(19) United States
(12) Patent Application Publication
(10) Pub. No.: US 2025/0126565 A1
(43) Pub. Date: Apr. 17, 2025

(54) SIGNALING AND PROCEDURE OF ENERGY HARVESTING INDICATION AND ENERGY HARVESTING MODE

(71) Applicant: QUALCOMM INCORPORATED, San Diego, CA (US)

(72) Inventors: Chao WEI, Beijing (CN); Ruiming ZHENG, Beijing (CN); Kangqi LIU, San Diego, CA (US); Hao XU, Beijing (CN)

(21) Appl. No.: 18/691,702

(22) PCT Filed: Oct. 15, 2021
(86) PCT No.: PCT/CN2021/124012

§ 371 Date: Mar. 13, 2024

(51) Int. Cl. H04W 52/02; H04L 5/00; H04W 76/27

(52) U.S. Cl. CPC H04W 52/0258; H04L 5/0048; H04W 76/27

(57) ABSTRACT

Methods, systems, and devices for wireless communications are described. A user equipment (UE) may indicate to the network (e.g., a base station that the UE is communicating with) that the UE is transitioning to an energy harvesting mode, and the network may transmit an indication of a radio resource that is configured for the energy harvesting mode. The UE may communicate with the network via the configured radio resource during the energy harvesting mode. The network may transmit one or more parameters that may trigger the UE to enter the energy harvesting mode. The UE may transmit an indication that the UE is transitioning out of the energy harvesting mode to a normal capability mode, or the UE may transmit an indication that the UE is staying in the energy harvesting mode. The network may indicate, to the UE, a radio resource for a normal capability mode.

### CROSS REFERENCE

The present Application is a 371 national stage filing of International PCT Application No. PCT/CN2021/124012 by WEI et al. entitled “SIGNALING AND PROCEDURE OF ENERGY HARVESTING INDICATION AND ENERGY HARVESTING MODE,” filed Oct. 15, 2021, which is assigned to the assignee hereof, and which is expressly incorporated by reference in its entirety herein.

### FIELD OF TECHNOLOGY

The following relates to wireless communications, including signaling and procedure of energy harvesting indication and energy harvesting mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support signaling and procedure of energy harvesting indication and energy harvesting mode. Generally, the described techniques provide for signaling between a user equipment (UE) configured to harvest energy and the network indicating that the UE is transitioning to an energy harvesting mode and signaling that configures radio resources for the UE during the energy harvesting mode. The UE may indicate to the network (e.g., a base station that the UE is communicating with) that the UE is transitioning to an energy harvesting mode, and the network may transmit an indication of a radio resource that is configured for the energy harvesting mode. The UE may communicate with the network via the configured radio resource during the energy harvesting mode. The network may also transmit one or more configuration parameters that may trigger the UE to enter the energy harvesting mode (e.g., a battery energy threshold or a battery energy level change amount). The network may configure an energy harvesting mode timer which indicates a duration the UE may stay in the energy harvesting mode. The UE may transmit an indication that the UE is transitioning out of the energy harvesting mode to a normal capability mode, or the UE may transmit an indication that the UE is staying in the energy harvesting mode (e.g., if the battery energy level remains below a threshold), based on the energy harvesting mode timer.

A method for wireless communications at a user equipment (UE) is described. The method may include transmitting, to a base station, an indication that the UE is transitioning to an energy harvesting mode based on a trigger, and a timing offset parameter indicating a timing offset between transmission of the indication and transitioning to the energy harvesting mode, receiving, from the base station, a control message indicating a radio resource configuration for the energy harvesting mode, prior to transitioning to the energy harvesting mode, and transitioning to the energy harvesting mode in accordance with the timing offset parameter.

An apparatus for wireless communications at a UE is described. The apparatus may include a processor, memory coupled with the processor, and instructions stored in the memory. The instructions may be executable by the processor to cause the apparatus to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Another apparatus for wireless communications at a UE is described. The apparatus may include means for transmitting, to a base station, an indication that the UE is transitioning to an energy harvesting mode based on a trigger, and a timing offset parameter indicating a timing offset between transmission of the indication and transitioning to the energy harvesting mode, means for receiving, from the base station, a control message indicating a radio resource configuration for the energy harvesting mode, prior to transitioning to the energy harvesting mode, and means for transitioning to the energy harvesting mode in accordance with the timing offset parameter.

A non-transitory computer-readable medium storing code for wireless communications at a UE is described. The code may include instructions executable by a processor to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Some examples of the method, apparatuses, and non-transitory computer-readable medium described herein may further include operations, features, means, or instructions for performing energy harvesting when the UE may be in a radio resource control idle mode, a radio resource control inactive mode, or a radio resource control connected mode.

Some examples of the method, apparatuses, and non-transitory computer-readable medium described herein may further include operations, features, means, or instructions for communicating with the base station using the radio resource configuration during the energy harvesting mode.

Some examples of the method, apparatuses, and non-transitory computer-readable medium described herein may further include operations, features, means, or instructions for maintaining a timer indicating a duration since a previous transmission by the UE of a previous indication that the UE may be transitioning to the energy harvesting mode, where transmitting the indication may be based on the timer exceeding a threshold duration.

Some examples of the method, apparatuses, and non-transitory computer-readable medium described herein may further include operations, features, means, or instructions for receiving, from the base station, control signaling indicating one or more parameters associated with the trigger, where the transmitting the indication that the UE may be transitioning to the energy harvesting mode may be based on the control signaling.

In some examples of the method, apparatuses, and non-transitory computer-readable medium described herein, receiving the control signaling may include operations, features, means, or instructions for receiving the control signaling via dedicated radio resource control signaling or a system information block.

In some examples of the method, apparatuses, and non-transitory computer-readable medium described herein, the one or more parameters includes an energy level threshold and the trigger may be based on an energy level being below the energy level threshold.

In some examples of the method, apparatuses, and non-transitory computer-readable medium described herein, the one or more parameters includes an energy level threshold and a duration threshold and the trigger may be based on an energy level of the UE being below the energy level threshold for at least the duration threshold.

In some examples of the method, apparatuses, and non-transitory computer-readable medium described herein, the one or more parameters includes an energy level change threshold and the trigger may be based on a change in an energy level of the UE exceeding the energy level change threshold.

Some examples of the method, apparatuses, and non-transitory computer-readable medium described herein may further include operations, features, means, or instructions for transmitting, to the base station, a scheduling request for an uplink resource and receiving, from the base station, a grant for the uplink resource based on the scheduling request, and where transmitting the indication that the UE may be transitioning to the energy harvesting mode includes transmitting the indication via the uplink resource.

In some examples of the method, apparatuses, and non-transitory computer-readable medium described herein, transmitting the indication that the UE may be transitioning to the energy harvesting mode may include operations, features, means, or instructions for transmitting the indication in a random access channel procedure.

In some examples of the method, apparatuses, and non-transitory computer-readable medium described herein, transmitting the indication that the UE may be transitioning to the energy harvesting mode may include operations, features, means, or instructions for transmitting the indication via a small data transmission.

In some examples of the method, apparatuses, and non-transitory computer-readable medium described herein, transmitting the indication may include operations, features, means, or instructions for transmitting: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

Some examples of the method, apparatuses, and non-transitory computer-readable medium described herein may further include operations, features, means, or instructions for restarting a timer associated with the timer parameter based on receiving the control message from the base station.

In some examples of the method, apparatuses, and non-transitory computer-readable medium described herein, receiving the control message may include operations, features, means, or instructions for receiving a second indication of a reduced capability radio resource configuration for the energy harvesting mode.

Some examples of the method, apparatuses, and non-transitory computer-readable medium described herein may further include operations, features, means, or instructions for receiving, from the base station, control signaling indicating a set of multiple reduced radio resource configurations, and where receiving the control message includes receiving a second indication of a reduced capability radio resource configuration of the set of multiple reduced radio resource configurations.

In some examples of the method, apparatuses, and non-transitory computer-readable medium described herein, receiving the control signaling may include operations, features, means, or instructions for receiving the control signaling via a radio resource control signal, where receiving the second indication includes and receiving the second indication via a medium access control control element signal or via a downlink control information signal.

Some examples of the method, apparatuses, and non-transitory computer-readable medium described herein may further include operations, features, means, or instructions for transmitting, to the base station, a capability indicator indicating a reduced capability radio resource configuration of the UE, where receiving the control message includes receiving a second indication to activate the reduced capability radio resource configuration of the UE for the energy harvesting mode based on the capability indicator.

Some examples of the method, apparatuses, and non-transitory computer-readable medium described herein may further include operations, features, means, or instructions for receiving system information indicating a reduced capability radio resource configuration for the UE, where receiving the control message includes receiving a second indication to activate the reduced capability radio resource configuration of the UE for the energy harvesting mode.

Some examples of the method, apparatuses, and non-transitory computer-readable medium described herein may further include operations, features, means, or instructions for transmitting, to the base station, a second indication that the UE may be transitioning out of the energy harvesting mode to a normal capability mode.

Some examples of the method, apparatuses, and non-transitory computer-readable medium described herein may further include operations, features, means, or instructions for receiving, from the base station, a second control message indicating a second radio resource configuration for the UE during the normal capability mode.

Some examples of the method, apparatuses, and non-transitory computer-readable medium described herein may further include operations, features, means, or instructions for maintaining a timer indicating a duration since a previous transmission by the UE of a previous indication that the UE may be transitioning out of the energy harvesting mode to the normal capability mode, where transmitting the indication may be based on the timer exceeding a threshold duration.

In some examples of the method, apparatuses, and non-transitory computer-readable medium described herein, transmitting the second indication that the UE may be transitioning out of the energy harvesting mode to the normal capability mode may include operations, features, means, or instructions for transmitting the second indication via a medium access control control element message or a radio resource control message.

Some examples of the method, apparatuses, and non-transitory computer-readable medium described herein may further include operations, features, means, or instructions for transmitting, to the base station, the indication or a second indication that the UE may be extending a duration of the energy harvesting mode.

In some examples of the method, apparatuses, and non-transitory computer-readable medium described herein, transmitting the indication or the second indication that the UE may be extending the duration of the energy harvesting mode may include operations, features, means, or instructions for transmitting the indication or the second indication via a medium access control control element message or a radio resource control message.

Some examples of the method, apparatuses, and non-transitory computer-readable medium described herein may further include operations, features, means, or instructions for receiving, from the base station, control signaling indicating for the UE to enter an idle mode, where the control signaling may be based on a duration of the energy harvesting mode.

In some examples of the method, apparatuses, and non-transitory computer-readable medium described herein, receiving the control signaling may include operations, features, means, or instructions for receiving the control signaling via a medium access control control element message or a radio resource control message.

A method for wireless communications at a base station is described. The method may include receiving, from a UE, an indication that the UE is transitioning to an energy harvesting mode based on a trigger, and a timing offset parameter indicating a timing offset between transmission of the indication and transitioning to the energy harvesting mode, transmitting, to the UE, a control message indicating a radio resource configuration for the energy harvesting mode, prior to the UE transitioning to the energy harvesting mode, and communicating with the UE using the radio resource configuration during the energy harvesting mode.

An apparatus for wireless communications at a base station is described. The apparatus may include a processor, memory coupled with the processor, and instructions stored in the memory. The instructions may be executable by the processor to cause the apparatus to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Another apparatus for wireless communications at a base station is described. The apparatus may include means for receiving, from a UE, an indication that the UE is transitioning to an energy harvesting mode based on a trigger, and a timing offset parameter indicating a timing offset between transmission of the indication and transitioning to the energy harvesting mode, means for transmitting, to the UE, a control message indicating a radio resource configuration for the energy harvesting mode, prior to the UE transitioning to the energy harvesting mode, and means for communicating with the UE using the radio resource configuration during the energy harvesting mode.

A non-transitory computer-readable medium storing code for wireless communications at a base station is described. The code may include instructions executable by a processor to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Some examples of the method, apparatuses, and non-transitory computer-readable medium described herein may further include operations, features, means, or instructions for transmitting, to the UE, control signaling indicating one or more parameters associated with triggering transitioning to the energy harvesting mode, where the receiving the indication that the UE may be transitioning to the energy harvesting mode may be based on the control signaling.

In some examples of the method, apparatuses, and non-transitory computer-readable medium described herein, transmitting the control signaling may include operations, features, means, or instructions for transmitting the control signaling via dedicated radio resource control signaling or a system information block.

In some examples of the method, apparatuses, and non-transitory computer-readable medium described herein, the one or more parameters includes an energy level threshold, and the trigger may be based on an energy level being below the energy level threshold.

In some examples of the method, apparatuses, and non-transitory computer-readable medium described herein, the one or more parameters includes an energy level threshold and a duration threshold, the trigger may be based on an energy level of the UE being below the energy level threshold for at least the duration threshold.

In some examples of the method, apparatuses, and non-transitory computer-readable medium described herein, the one or more parameters includes an energy level change threshold, the trigger may be based on a change in an energy level of the UE exceeding the energy level change threshold.

Some examples of the method, apparatuses, and non-transitory computer-readable medium described herein may further include operations, features, means, or instructions for receiving, from the UE, a scheduling request for an uplink resource and transmitting, to the UE, a grant for the uplink resource based on the scheduling request, and where receiving the indication that the UE may be transitioning to the energy harvesting mode includes receiving the indication via the uplink resource.

In some examples of the method, apparatuses, and non-transitory computer-readable medium described herein, receiving the indication that the UE may be transitioning to the energy harvesting mode may include operations, features, means, or instructions for receiving the indication in a random access channel procedure.

In some examples of the method, apparatuses, and non-transitory computer-readable medium described herein, receiving the indication that the UE may be transitioning to the energy harvesting mode may include operations, features, means, or instructions for receiving the indication via a small data transmission.

In some examples of the method, apparatuses, and non-transitory computer-readable medium described herein, receiving the indication may include operations, features, means, or instructions for receiving: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

In some examples of the method, apparatuses, and non-transitory computer-readable medium described herein, transmitting the control message may include operations, features, means, or instructions for transmitting a second indication of a reduced capability radio resource configuration for the UE during the energy harvesting mode.

Some examples of the method, apparatuses, and non-transitory computer-readable medium described herein may further include operations, features, means, or instructions for transmitting, to the UE, control signaling indicating a set of multiple reduced radio resource configurations, and where transmitting the control message includes transmitting a second indication of a reduced capability radio resource configuration of the set of multiple reduced radio resource configurations.

In some examples of the method, apparatuses, and non-transitory computer-readable medium described herein, transmitting the control signaling may include operations, features, means, or instructions for transmitting the control signaling via a radio resource control signal, and where transmitting the second indication includes transmitting the second indication via a medium access control control element signal or via a downlink control information signal.

Some examples of the method, apparatuses, and non-transitory computer-readable medium described herein may further include operations, features, means, or instructions for receiving, from the UE, a capability indicator indicating a reduced capability radio resource configuration of the UE, where transmitting the control message includes transmitting a second indication to activate the reduced capability radio resource configuration of the UE for the energy harvesting mode may be based on the capability indicator.

Some examples of the method, apparatuses, and non-transitory computer-readable medium described herein may further include operations, features, means, or instructions for transmitting, to the UE, system information indicating a reduced capability radio resource configuration for the UE, where transmitting the control message includes transmitting a second indication to activate the reduced capability radio resource configuration of the UE for the energy harvesting mode.

Some examples of the method, apparatuses, and non-transitory computer-readable medium described herein may further include operations, features, means, or instructions for receiving, from the UE, a second indication that the UE may be transitioning out of the energy harvesting mode to a normal capability mode.

Some examples of the method, apparatuses, and non-transitory computer-readable medium described herein may further include operations, features, means, or instructions for transmitting, to the UE, a second control message indicating a second radio resource configuration for the UE during the normal capability mode.

In some examples of the method, apparatuses, and non-transitory computer-readable medium described herein, receiving the second indication that the UE may be transitioning out of the energy harvesting mode to the normal capability mode may include operations, features, means, or instructions for receiving the second indication via a medium access control control element message or a radio resource control message.

Some examples of the method, apparatuses, and non-transitory computer-readable medium described herein may further include operations, features, means, or instructions for receiving, from the UE, the indication or a second indication that the UE may be extending a duration of the energy harvesting mode.

In some examples of the method, apparatuses, and non-transitory computer-readable medium described herein, receiving the indication or the second indication that the UE may be extending the duration of the energy harvesting mode may include operations, features, means, or instructions for receiving the indication or the second indication via a medium access control control element message or a radio resource control message.

Some examples of the method, apparatuses, and non-transitory computer-readable medium described herein may further include operations, features, means, or instructions for transmitting, to the UE, control signaling indicating for the UE to enter an idle mode, where the control signaling may be based on a duration of the energy harvesting mode.

In some examples of the method, apparatuses, and non-transitory computer-readable medium described herein, transmitting the control signaling indicating for the UE to enter the idle mode may include operations, features, means, or instructions for transmitting the control signaling via a medium access control control element message or a radio resource control message.

A method for wireless communications at a UE is described. The method may include transmitting, to a base station, an indication that the UE is transitioning to an energy harvesting mode based on a trigger, and a timing offset parameter indicating a timing offset between transmission of the indication and transitioning to the energy harvesting mode, receiving, from the base station, a control message indicating a radio resource configuration for the energy harvesting mode, prior to transitioning to the energy harvesting mode, and transitioning to the energy harvesting mode in accordance with the timing offset parameter.

An apparatus for wireless communications at a UE is described. The apparatus may include a processor, memory coupled with the processor, and instructions stored in the memory. The instructions may be executable by the processor to cause the apparatus to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Another apparatus for wireless communications at a UE is described. The apparatus may include means for transmitting, to a base station, an indication that the UE is transitioning to an energy harvesting mode based on a trigger, and a timing offset parameter indicating a timing offset between transmission of the indication and transitioning to the energy harvesting mode, means for receiving, from the base station, a control message indicating a radio resource configuration for the energy harvesting mode, prior to transitioning to the energy harvesting mode, and means for transitioning to the energy harvesting mode in accordance with the timing offset parameter.

A non-transitory computer-readable medium storing code for wireless communications at a UE is described. The code may include instructions executable by a processor to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Some examples of the apparatus may include means for performing energy harvesting when the UE may be in a radio resource control idle mode, a radio resource control inactive mode, or a radio resource control connected mode.

Some examples of the apparatus may include means for communicating with the base station using the radio resource configuration during the energy harvesting mode.

Some examples of the apparatus may include means for maintaining a timer indicating a duration since a previous transmission by the UE of a previous indication that the UE may be transitioning to the energy harvesting mode, where transmitting the indication may be based on the timer exceeding a threshold duration.

Some examples of the apparatus may include means for receiving, from the base station, control signaling indicating one or more parameters associated with the trigger, where the transmitting the indication that the UE may be transitioning to the energy harvesting mode may be based on the control signaling.

In some examples of the method, apparatuses, and non-transitory computer-readable medium described herein, receiving the control signaling may include operations, features, means, or instructions for receiving the control signaling via dedicated radio resource control signaling or a system information block.

In some examples of the method, apparatuses, and non-transitory computer-readable medium described herein, the one or more parameters includes an energy level threshold and the trigger may be based on an energy level being below the energy level threshold.

In some examples of the method, apparatuses, and non-transitory computer-readable medium described herein, the one or more parameters includes an energy level threshold and a duration threshold and the trigger may be based on an energy level of the UE being below the energy level threshold for at least the duration threshold.

In some examples of the method, apparatuses, and non-transitory computer-readable medium described herein, the one or more parameters includes an energy level change threshold and the trigger may be based on a change in an energy level of the UE exceeding the energy level change threshold.

Some examples of the apparatus may include means for transmitting, to the base station, a scheduling request for an uplink resource and means for receiving, from the base station, a grant for the uplink resource based on the scheduling request, and where transmitting the indication that the UE may be transitioning to the energy harvesting mode includes transmitting the indication via the uplink resource.

In some examples of the method, apparatuses, and non-transitory computer-readable medium described herein, transmitting the indication that the UE may be transitioning to the energy harvesting mode may include operations, features, means, or instructions for transmitting the indication in a random access channel procedure.

In some examples of the method, apparatuses, and non-transitory computer-readable medium described herein, transmitting the indication that the UE may be transitioning to the energy harvesting mode may include operations, features, means, or instructions for transmitting the indication via a small data transmission.

In some examples of the method, apparatuses, and non-transitory computer-readable medium described herein, transmitting the indication may include operations, features, means, or instructions for transmitting: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

Some examples of the apparatus may include means for restarting a timer associated with the timer parameter based on receiving the control message from the base station.

In some examples of the method, apparatuses, and non-transitory computer-readable medium described herein, receiving the control message may include operations, features, means, or instructions for receiving a second indication of a reduced capability radio resource configuration for the energy harvesting mode.

Some examples of the apparatus may include means for receiving, from the base station, control signaling indicating a set of multiple reduced radio resource configurations, and where receiving the control message includes receiving a second indication of a reduced capability radio resource configuration of the set of multiple reduced radio resource configurations.

In some examples of the method, apparatuses, and non-transitory computer-readable medium described herein, receiving the control signaling may include operations, features, means, or instructions for receiving the control signaling via a radio resource control signal, where receiving the second indication includes and means for receiving the second indication via a medium access control control element signal or via a downlink control information signal.

Some examples of the apparatus may include means for transmitting, to the base station, a capability indicator indicating a reduced capability radio resource configuration of the UE, where receiving the control message includes receiving a second indication to activate the reduced capability radio resource configuration of the UE for the energy harvesting mode based on the capability indicator.

Some examples of the apparatus may include means for receiving system information indicating a reduced capability radio resource configuration for the UE, where the means for receiving the control message includes means for receiving a second indication to activate the reduced capability radio resource configuration of the UE for the energy harvesting mode.

Some examples of the apparatus may include means for transmitting, to the base station, a second indication that the UE may be transitioning out of the energy harvesting mode to a normal capability mode.

Some examples of the apparatus may include means for receiving, from the base station, a second control message indicating a second radio resource configuration for the UE during the normal capability mode.

Some examples of the apparatus may include means for maintaining a timer indicating a duration since a previous transmission by the UE of a previous indication that the UE may be transitioning out of the energy harvesting mode to the normal capability mode, where transmitting the indication may be based on the timer exceeding a threshold duration.

In some examples of the method, apparatuses, and non-transitory computer-readable medium described herein, transmitting the second indication that the UE may be transitioning out of the energy harvesting mode to the normal capability mode may include operations, features, means, or instructions for transmitting the second indication via a medium access control control element message or a radio resource control message.

Some examples of the apparatus may include means for transmitting, to the base station, the indication or a second indication that the UE may be extending a duration of the energy harvesting mode.

In some examples of the method, apparatuses, and non-transitory computer-readable medium described herein, transmitting the indication or the second indication that the UE may be extending the duration of the energy harvesting mode may include operations, features, means, or instructions for transmitting the indication or the second indication via a medium access control control element message or a radio resource control message.

Some examples of the apparatus may include means for receiving, from the base station, control signaling indicating for the UE to enter an idle mode, where the control signaling may be based on a duration of the energy harvesting mode.

In some examples of the method, apparatuses, and non-transitory computer-readable medium described herein, receiving the control signaling may include operations, features, means, or instructions for receiving the control signaling via a medium access control control element message or a radio resource control message.

A method for wireless communications at a base station is described. The method may include receiving, from a UE, an indication that the UE is transitioning to an energy harvesting mode based on a trigger, and a timing offset parameter indicating a timing offset between transmission of the indication and transitioning to the energy harvesting mode, transmitting, to the UE, a control message indicating a radio resource configuration for the energy harvesting mode, prior to the UE transitioning to the energy harvesting mode, and communicating with the UE using the radio resource configuration during the energy harvesting mode.

An apparatus for wireless communications at a base station is described. The apparatus may include a processor, memory coupled with the processor, and instructions stored in the memory. The instructions may be executable by the processor to cause the apparatus to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Another apparatus for wireless communications at a base station is described. The apparatus may include means for receiving, from a UE, an indication that the UE is transitioning to an energy harvesting mode based on a trigger, and a timing offset parameter indicating a timing offset between transmission of the indication and transitioning to the energy harvesting mode, means for transmitting, to the UE, a control message indicating a radio resource configuration for the energy harvesting mode, prior to the UE transitioning to the energy harvesting mode, and means for communicating with the UE using the radio resource configuration during the energy harvesting mode.

A non-transitory computer-readable medium storing code for wireless communications at a base station is described. The code may include instructions executable by a processor to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Some examples of the apparatus may include means for transmitting, to the UE, control signaling indicating one or more parameters associated with triggering transitioning to the energy harvesting mode, where the receiving the indication that the UE may be transitioning to the energy harvesting mode may be based on the control signaling.

In some examples of the method, apparatuses, and non-transitory computer-readable medium described herein, transmitting the control signaling may include operations, features, means, or instructions for transmitting the control signaling via dedicated radio resource control signaling or a system information block.

In some examples of the method, apparatuses, and non-transitory computer-readable medium described herein, the one or more parameters includes an energy level threshold, and the trigger may be based on an energy level being below the energy level threshold.

In some examples of the method, apparatuses, and non-transitory computer-readable medium described herein, the one or more parameters includes an energy level threshold and a duration threshold, the trigger may be based on an energy level of the UE being below the energy level threshold for at least the duration threshold.

In some examples of the method, apparatuses, and non-transitory computer-readable medium described herein, the one or more parameters includes an energy level change threshold, the trigger may be based on a change in an energy level of the UE exceeding the energy level change threshold.

Some examples of the apparatus may include means for receiving, from the UE, a scheduling request for an uplink resource and means for transmitting, to the UE, a grant for the uplink resource based on the scheduling request, and where receiving the indication that the UE may be transitioning to the energy harvesting mode includes receiving the indication via the uplink resource.

In some examples of the method, apparatuses, and non-transitory computer-readable medium described herein, receiving the indication that the UE may be transitioning to the energy harvesting mode may include operations, features, means, or instructions for receiving the indication in a random access channel procedure.

In some examples of the method, apparatuses, and non-transitory computer-readable medium described herein, receiving the indication that the UE may be transitioning to the energy harvesting mode may include operations, features, means, or instructions for receiving the indication via a small data transmission.

In some examples of the method, apparatuses, and non-transitory computer-readable medium described herein, receiving the indication may include operations, features, means, or instructions for receiving: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

In some examples of the method, apparatuses, and non-transitory computer-readable medium described herein, transmitting the control message may include operations, features, means, or instructions for transmitting a second indication of a reduced capability radio resource configuration for the UE during the energy harvesting mode.

Some examples of the apparatus may include means for transmitting, to the UE, control signaling indicating a set of multiple reduced radio resource configurations, and where transmitting the control message includes transmitting a second indication of a reduced capability radio resource configuration of the set of multiple reduced radio resource configurations.

In some examples of the method, apparatuses, and non-transitory computer-readable medium described herein, transmitting the control signaling may include operations, features, means, or instructions for transmitting the control signaling via a radio resource control signal, and where transmitting the second indication includes transmitting the second indication via a medium access control control element signal or via a downlink control information signal.

Some examples of the apparatus may include means for receiving, from the UE, a capability indicator indicating a reduced capability radio resource configuration of the UE, where transmitting the control message includes transmitting a second indication to activate the reduced capability radio resource configuration of the UE for the energy harvesting mode may be based on the capability indicator.

Some examples of the apparatus may include means for transmitting, to the UE, system information indicating a reduced capability radio resource configuration for the UE, where the means for transmitting the control message includes means for transmitting a second indication to activate the reduced capability radio resource configuration of the UE for the energy harvesting mode.

Some examples of the apparatus may include means for receiving, from the UE, a second indication that the UE may be transitioning out of the energy harvesting mode to a normal capability mode.

Some examples of the apparatus may include means for transmitting, to the UE, a second control message indicating a second radio resource configuration for the UE during the normal capability mode.

In some examples of the method, apparatuses, and non-transitory computer-readable medium described herein, receiving the second indication that the UE may be transitioning out of the energy harvesting mode to the normal capability mode may include operations, features, means, or instructions for receiving the second indication via a medium access control control element message or a radio resource control message.

Some examples of the apparatus may include means for receiving, from the UE, the indication or a second indication that the UE may be extending a duration of the energy harvesting mode.

In some examples of the method, apparatuses, and non-transitory computer-readable medium described herein, receiving the indication or the second indication that the UE may be extending the duration of the energy harvesting mode may include operations, features, means, or instructions for receiving the indication or the second indication via a medium access control control element message or a radio resource control message.

Some examples of the apparatus may include means for transmitting, to the UE, control signaling indicating for the UE to enter an idle mode, where the control signaling may be based on a duration of the energy harvesting mode.

In some examples of the method, apparatuses, and non-transitory computer-readable medium described herein, transmitting the control signaling indicating for the UE to enter the idle mode may include operations, features, means, or instructions for transmitting the control signaling via a medium access control control element message or a radio resource control message.

A method for wireless communications at a UE is described. The method may include transmitting, to a base station, an indication that the UE is transitioning to an energy harvesting mode based on a trigger, and a timing offset parameter indicating a timing offset between transmission of the indication and transitioning to the energy harvesting mode, receiving, from the base station, a control message indicating a radio resource configuration for the energy harvesting mode, prior to transitioning to the energy harvesting mode, and transition to the energy harvesting mode in accordance with the timing offset parameter.

An apparatus for wireless communications at a UE is described. The apparatus may include a processor, memory coupled with the processor, and instructions stored in the memory. The instructions may be executable by the processor to cause the apparatus to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Another apparatus for wireless communications at a UE is described. The apparatus may include means for transmitting, to a base station, an indication that the UE is transitioning to an energy harvesting mode based on a trigger, and a timing offset parameter indicating a timing offset between transmission of the indication and transitioning to the energy harvesting mode, means for receiving, from the base station, a control message indicating a radio resource configuration for the energy harvesting mode, prior to transitioning to the energy harvesting mode, and means for transition to the energy harvesting mode in accordance with the timing offset parameter.

A non-transitory computer-readable medium storing code for wireless communications at a UE is described. The code may include instructions executable by a processor to transmit, to a base station, an indication that the UE is transitioning to an energy harvesting mode based on a trigger, and a timing offset parameter indicating a timing offset between transmission of the indication and transitioning to the energy harvesting mode, receive, from the base station, a control message indicating a radio resource configuration for the energy harvesting mode, prior to transitioning to the energy harvesting mode, and transition to the energy harvesting mode in accordance with the timing offset parameter.

Some examples of the method, apparatuses, and non-transitory computer-readable medium described herein may further include operations, features, means, or instructions for performing energy harvesting when the UE may be in a radio resource control idle mode, a radio resource control inactive mode, or a radio resource control connected mode.

Some examples of the method, apparatuses, and non-transitory computer-readable medium described herein may further include operations, features, means, or instructions for communicating with the base station using the radio resource configuration during the energy harvesting mode.

Some examples of the method, apparatuses, and non-transitory computer-readable medium described herein may further include operations, features, means, or instructions for maintaining a timer indicating a duration since a previous transmission by the UE of a previous indication that the UE may be transitioning to the energy harvesting mode, where transmitting the indication may be based on the timer exceeding a threshold duration.

Some examples of the method, apparatuses, and non-transitory computer-readable medium described herein may further include operations, features, means, or instructions for receiving, from the base station, control signaling indicating one or more parameters associated with the trigger, where the transmitting the indication that the UE may be transitioning to the energy harvesting mode may be based on the control signaling.

In some examples of the method, apparatuses, and non-transitory computer-readable medium described herein, receiving the control signaling may include operations, features, means, or instructions for receiving the control signaling via dedicated radio resource control signaling or a system information block.

In some examples of the method, apparatuses, and non-transitory computer-readable medium described herein, the one or more parameters includes an energy level threshold and the trigger may be based on an energy level being below the energy level threshold.

In some examples of the method, apparatuses, and non-transitory computer-readable medium described herein, the one or more parameters includes an energy level threshold and a duration threshold and the trigger may be based on an energy level of the UE being below the energy level threshold for at least the duration threshold.

In some examples of the method, apparatuses, and non-transitory computer-readable medium described herein, the one or more parameters includes an energy level change threshold and the trigger may be based on a change in an energy level of the UE exceeding the energy level change threshold.

Some examples of the method, apparatuses, and non-transitory computer-readable medium described herein may further include operations, features, means, or instructions for transmitting, to the base station, a scheduling request for an uplink resource and receive, from the base station, a grant for the uplink resource based on the scheduling request, and where transmitting the indication that the UE may be transitioning to the energy harvesting mode includes transmitting the indication via the uplink resource.

In some examples of the method, apparatuses, and non-transitory computer-readable medium described herein, transmitting the indication that the UE may be transitioning to the energy harvesting mode may include operations, features, means, or instructions for transmitting the indication in a random access channel procedure.

In some examples of the method, apparatuses, and non-transitory computer-readable medium described herein, transmitting the indication that the UE may be transitioning to the energy harvesting mode may include operations, features, means, or instructions for transmitting the indication via a small data transmission.

In some examples of the method, apparatuses, and non-transitory computer-readable medium described herein, transmitting the indication may include operations, features, means, or instructions for transmitting: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

Some examples of the method, apparatuses, and non-transitory computer-readable medium described herein may further include operations, features, means, or instructions for restarting a timer associated with the timer parameter based on receiving the control message from the base station.

In some examples of the method, apparatuses, and non-transitory computer-readable medium described herein, receiving the control message may include operations, features, means, or instructions for receiving a second indication of a reduced capability radio resource configuration for the energy harvesting mode.

Some examples of the method, apparatuses, and non-transitory computer-readable medium described herein may further include operations, features, means, or instructions for receiving, from the base station, control signaling indicating a set of multiple reduced radio resource configurations, and where receiving the control message includes receiving a second indication of a reduced capability radio resource configuration of the set of multiple reduced radio resource configurations.

In some examples of the method, apparatuses, and non-transitory computer-readable medium described herein, receiving the control signaling may include operations, features, means, or instructions for receiving the control signaling via a radio resource control signal, where receiving the second indication includes and receive the second indication via a medium access control control element signal or via a downlink control information signal.

Some examples of the method, apparatuses, and non-transitory computer-readable medium described herein may further include operations, features, means, or instructions for transmitting, to the base station, a capability indicator indicating a reduced capability radio resource configuration of the UE, where receiving the control message includes receiving a second indication to activate the reduced capability radio resource configuration of the UE for the energy harvesting mode based on the capability indicator.

Some examples of the method, apparatuses, and non-transitory computer-readable medium described herein may further include operations, features, means, or instructions for receiving system information indicating a reduced capability radio resource configuration for the UE, where receiving the control message includes receiving a second indication to activate the reduced capability radio resource configuration of the UE for the energy harvesting mode.

Some examples of the method, apparatuses, and non-transitory computer-readable medium described herein may further include operations, features, means, or instructions for transmitting, to the base station, a second indication that the UE may be transitioning out of the energy harvesting mode to a normal capability mode.

Some examples of the method, apparatuses, and non-transitory computer-readable medium described herein may further include operations, features, means, or instructions for receiving, from the base station, a second control message indicating a second radio resource configuration for the UE during the normal capability mode.

Some examples of the method, apparatuses, and non-transitory computer-readable medium described herein may further include operations, features, means, or instructions for maintaining a timer indicating a duration since a previous transmission by the UE of a previous indication that the UE may be transitioning out of the energy harvesting mode to the normal capability mode, where transmitting the indication may be based on the timer exceeding a threshold duration.

In some examples of the method, apparatuses, and non-transitory computer-readable medium described herein, transmitting the second indication that the UE may be transitioning out of the energy harvesting mode to the normal capability mode may include operations, features, means, or instructions for transmitting the second indication via a medium access control control element message or a radio resource control message.

Some examples of the method, apparatuses, and non-transitory computer-readable medium described herein may further include operations, features, means, or instructions for transmitting, to the base station, the indication or a second indication that the UE may be extending a duration of the energy harvesting mode.

In some examples of the method, apparatuses, and non-transitory computer-readable medium described herein, transmitting the indication or the second indication that the UE may be extending the duration of the energy harvesting mode may include operations, features, means, or instructions for transmitting the indication or the second indication via a medium access control control element message or a radio resource control message.

Some examples of the method, apparatuses, and non-transitory computer-readable medium described herein may further include operations, features, means, or instructions for receiving, from the base station, control signaling indicating for the UE to enter an idle mode, where the control signaling may be based on a duration of the energy harvesting mode.

In some examples of the method, apparatuses, and non-transitory computer-readable medium described herein, receiving the control signaling may include operations, features, means, or instructions for receiving the control signaling via a medium access control control element message or a radio resource control message.

A method for wireless communications at a base station is described. The method may include receiving, from a UE, an indication that the UE is transitioning to an energy harvesting mode based on a trigger, and a timing offset parameter indicating a timing offset between transmission of the indication and transitioning to the energy harvesting mode, transmitting, to the UE, a control message indicating a radio resource configuration for the energy harvesting mode, prior to the UE transitioning to the energy harvesting mode, and communicating with the UE using the radio resource configuration during the energy harvesting mode.

An apparatus for wireless communications at a base station is described. The apparatus may include a processor, memory coupled with the processor, and instructions stored in the memory. The instructions may be executable by the processor to cause the apparatus to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Another apparatus for wireless communications at a base station is described. The apparatus may include means for receiving, from a UE, an indication that the UE is transitioning to an energy harvesting mode based on a trigger, and a timing offset parameter indicating a timing offset between transmission of the indication and transitioning to the energy harvesting mode, means for transmitting, to the UE, a control message indicating a radio resource configuration for the energy harvesting mode, prior to the UE transitioning to the energy harvesting mode, and means for communicating with the UE using the radio resource configuration during the energy harvesting mode.

A non-transitory computer-readable medium storing code for wireless communications at a base station is described. The code may include instructions executable by a processor to receive, from a UE, an indication that the UE is transitioning to an energy harvesting mode based on a trigger, and a timing offset parameter indicating a timing offset between transmission of the indication and transitioning to the energy harvesting mode, transmit, to the UE, a control message indicating a radio resource configuration for the energy harvesting mode, prior to the UE transitioning to the energy harvesting mode, and communicate with the UE using the radio resource configuration during the energy harvesting mode.

Some examples of the method, apparatuses, and non-transitory computer-readable medium described herein may further include operations, features, means, or instructions for transmitting, to the UE, control signaling indicating one or more parameters associated with triggering transitioning to the energy harvesting mode, where the receiving the indication that the UE may be transitioning to the energy harvesting mode may be based on the control signaling.

In some examples of the method, apparatuses, and non-transitory computer-readable medium described herein, transmitting the control signaling may include operations, features, means, or instructions for transmitting the control signaling via dedicated radio resource control signaling or a system information block.

In some examples of the method, apparatuses, and non-transitory computer-readable medium described herein, the one or more parameters includes an energy level threshold, and the trigger may be based on an energy level being below the energy level threshold.

In some examples of the method, apparatuses, and non-transitory computer-readable medium described herein, the one or more parameters includes an energy level threshold and a duration threshold, the trigger may be based on an energy level of the UE being below the energy level threshold for at least the duration threshold.

In some examples of the method, apparatuses, and non-transitory computer-readable medium described herein, the one or more parameters includes an energy level change threshold, the trigger may be based on a change in an energy level of the UE exceeding the energy level change threshold.

Some examples of the method, apparatuses, and non-transitory computer-readable medium described herein may further include operations, features, means, or instructions for receiving, from the UE, a scheduling request for an uplink resource and transmit, to the UE, a grant for the uplink resource based on the scheduling request, and where receiving the indication that the UE may be transitioning to the energy harvesting mode includes receiving the indication via the uplink resource.

In some examples of the method, apparatuses, and non-transitory computer-readable medium described herein, receiving the indication that the UE may be transitioning to the energy harvesting mode may include operations, features, means, or instructions for receiving the indication in a random access channel procedure.

In some examples of the method, apparatuses, and non-transitory computer-readable medium described herein, receiving the indication that the UE may be transitioning to the energy harvesting mode may include operations, features, means, or instructions for receiving the indication via a small data transmission.

In some examples of the method, apparatuses, and non-transitory computer-readable medium described herein, receiving the indication may include operations, features, means, or instructions for receiving: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

In some examples of the method, apparatuses, and non-transitory computer-readable medium described herein, transmitting the control message may include operations, features, means, or instructions for transmitting a second indication of a reduced capability radio resource configuration for the UE during the energy harvesting mode.

Some examples of the method, apparatuses, and non-transitory computer-readable medium described herein may further include operations, features, means, or instructions for transmitting, to the UE, control signaling indicating a set of multiple reduced radio resource configurations, and where transmitting the control message includes transmitting a second indication of a reduced capability radio resource configuration of the set of multiple reduced radio resource configurations.

In some examples of the method, apparatuses, and non-transitory computer-readable medium described herein, transmitting the control signaling may include operations, features, means, or instructions for transmitting the control signaling via a radio resource control signal, and where transmitting the second indication includes transmitting the second indication via a medium access control control element signal or via a downlink control information signal.

Some examples of the method, apparatuses, and non-transitory computer-readable medium described herein may further include operations, features, means, or instructions for receiving, from the UE, a capability indicator indicating a reduced capability radio resource configuration of the UE, where transmitting the control message includes transmitting a second indication to activate the reduced capability radio resource configuration of the UE for the energy harvesting mode may be based on the capability indicator.

Some examples of the method, apparatuses, and non-transitory computer-readable medium described herein may further include operations, features, means, or instructions for transmitting, to the UE, system information indicating a reduced capability radio resource configuration for the UE, where transmitting the control message includes transmitting a second indication to activate the reduced capability radio resource configuration of the UE for the energy harvesting mode.

Some examples of the method, apparatuses, and non-transitory computer-readable medium described herein may further include operations, features, means, or instructions for receiving, from the UE, a second indication that the UE may be transitioning out of the energy harvesting mode to a normal capability mode.

Some examples of the method, apparatuses, and non-transitory computer-readable medium described herein may further include operations, features, means, or instructions for transmitting, to the UE, a second control message indicating a second radio resource configuration for the UE during the normal capability mode.

In some examples of the method, apparatuses, and non-transitory computer-readable medium described herein, receiving the second indication that the UE may be transitioning out of the energy harvesting mode to the normal capability mode may include operations, features, means, or instructions for receiving the second indication via a medium access control control element message or a radio resource control message.

Some examples of the method, apparatuses, and non-transitory computer-readable medium described herein may further include operations, features, means, or instructions for receiving, from the UE, the indication or a second indication that the UE may be extending a duration of the energy harvesting mode.

In some examples of the method, apparatuses, and non-transitory computer-readable medium described herein, receiving the indication or the second indication that the UE may be extending the duration of the energy harvesting mode may include operations, features, means, or instructions for receiving the indication or the second indication via a medium access control control element message or a radio resource control message.

Some examples of the method, apparatuses, and non-transitory computer-readable medium described herein may further include operations, features, means, or instructions for transmitting, to the UE, control signaling indicating for the UE to enter an idle mode, where the control signaling may be based on a duration of the energy harvesting mode.

In some examples of the method, apparatuses, and non-transitory computer-readable medium described herein, transmitting the control signaling indicating for the UE to enter the idle mode may include operations, features, means, or instructions for transmitting the control signaling via a medium access control control element message or a radio resource control message.

### BRIEF DESCRIPTION OF THE DRAWINGS

FIG. 1 illustrates an example of a wireless communications system that supports signaling and procedure of energy harvesting indication and energy harvesting mode in accordance with aspects of the present disclosure.

FIG. 2 illustrates an example of a wireless communications system that supports signaling and procedure of energy harvesting indication and energy harvesting mode in accordance with aspects of the present disclosure.

FIG. 3 illustrates an example of a process flow that supports signaling and procedure of energy harvesting indication and energy harvesting mode in accordance with aspects of the present disclosure.

FIG. 4 illustrates an example of a process flow that supports signaling and procedure of energy harvesting indication and energy harvesting mode in accordance with aspects of the present disclosure.

FIG. 5 illustrates an example of a process flow that supports signaling and procedure of energy harvesting indication and energy harvesting mode in accordance with aspects of the present disclosure.

FIGS. 6 and 7 show diagrams of devices that support signaling and procedure of energy harvesting indication and energy harvesting mode in accordance with aspects of the present disclosure.

FIG. 8 shows a diagram of a communications manager that supports signaling and procedure of energy harvesting indication and energy harvesting mode in accordance with aspects of the present disclosure.

FIG. 9 shows a diagram of a system including a device that supports signaling and procedure of energy harvesting indication and energy harvesting mode in accordance with aspects of the present disclosure.

FIGS. 10 and 11 show diagrams of devices that support signaling and procedure of energy harvesting indication and energy harvesting mode in accordance with aspects of the present disclosure.

FIG. 12 shows a diagram of a communications manager that supports signaling and procedure of energy harvesting indication and energy harvesting mode in accordance with aspects of the present disclosure.

FIG. 13 shows a diagram of a system including a device that supports signaling and procedure of energy harvesting indication and energy harvesting mode in accordance with aspects of the present disclosure.

FIGS. 14 through 22 show flowcharts illustrating methods that support signaling and procedure of energy harvesting indication and energy harvesting mode in accordance with aspects of the present disclosure.

### DETAILED DESCRIPTION

In some wireless communications systems, a user equipment (UE) may be capable of performing energy harvesting, meaning that the UE may harvest energy from the environment (e.g., from solar energy, ambient thermal energy, ambient radio frequency (RF) radiation). In some examples, a UE may store harvested energy in a rechargeable battery. During energy harvesting operations, a UE may work under battery-less conditions or a limited energy storage operation. During an energy harvesting mode, the power consumed by the UE should generally not exceed the harvested power. An amount of energy harvested may not be stable and continuous, for example an amount of energy harvested may vary with time. UEs operating on intermittently available harvested energy may be unable to sustain long or continuous reception and transmission. Communications with the network may be terminated from the UE side during an energy harvesting mode or period. The network may be unaware that the UE is operating in an energy harvesting mode, which may result in interruptions in communications or inefficient assignment of radio resources or scheduling of communications.

A UE configured to harvest energy may transmit signaling to the network indicating that the UE is transitioning to an energy harvesting mode and the network may transmit signaling that configures radio resources for the UE during the energy harvesting mode. The UE may indicate to the network (e.g., a base station that the UE is communicating with) that the UE is transitioning to an energy harvesting mode, and the network may transmit an indication of a radio resource that is configured for the energy harvesting mode. The UE may also indicate the rate at which the UE harvests energy and the real-time consumed and harvested power levels.

The UE may communicate with the network via the configured radio resource during the energy harvesting mode. The UE may operate in an energy harvesting mode while in any radio resource control (RRC) state. For example, the UE may operate in an energy harvesting mode in an RRC idle mode, an RRC inactive mode, or an RRC connected mode. The network may configure the UE to operate with a reduced capability or limited capability radio resource during the energy harvesting mode for power saving purposes. For example, a reduced capability or limited capability radio resource may support intermittent transmission on the data communication (UP) connection or via the RRC connection with the network.

The network may also transmit one or more configuration parameters that may trigger the UE to enter the energy harvesting mode (e.g., a battery energy threshold or a battery energy level change amount). The network may configure an energy harvesting mode timer which indicates a duration the UE may stay in the energy harvesting mode.

The UE may report its status when in an energy harvesting mode, for example whether the UE is ready to move out of the energy harvesting mode to a normal capability mode. The UE may transmit an indication that the UE is transitioning out of the energy harvesting mode to a normal capability mode (e.g., that energy harvesting is complete), or the UE may transmit an indication that the UE is staying in the energy harvesting mode (e.g., if the battery energy level remains below a threshold), based on the energy harvesting mode timer. If the UE reports that the UE is ready to transition out of the energy harvesting mode to a normal capability mode, the network may provide a radio resource configuration for the normal capability mode.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to signaling and procedure of energy harvesting indication and energy harvesting mode.

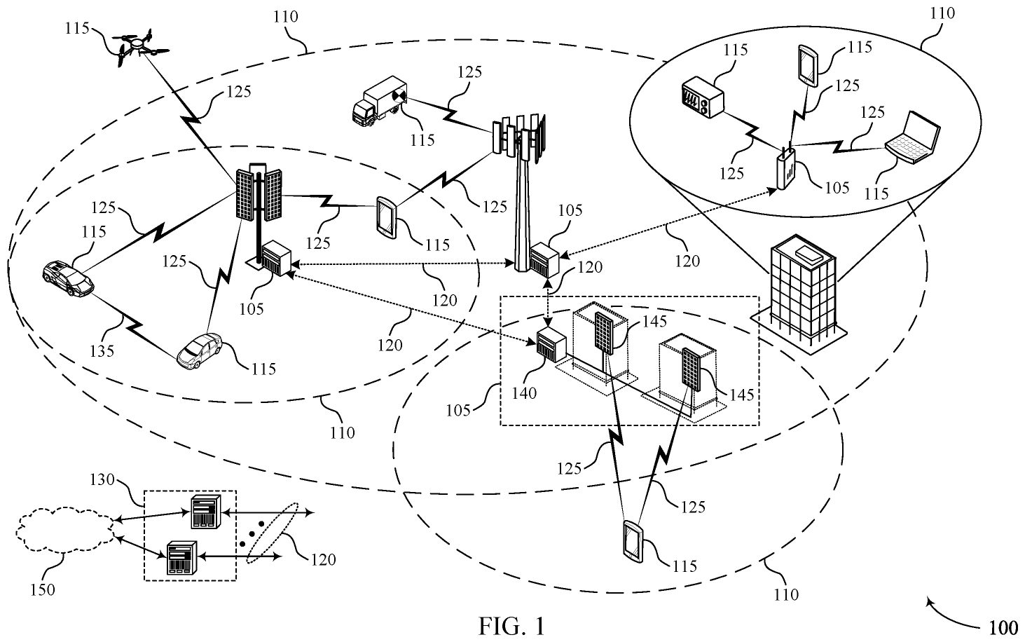

FIG. 1 illustrates an example of a wireless communications system 100 that supports signaling and procedure of energy harvesting indication and energy harvesting mode in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may be configured to harvest energy. A UE 115 configured to harvest energy may transmit signaling to the network (e.g., a base station 105 the UE 115 is communication with) indicating that the UE 115 is transitioning to an energy harvesting mode and the base station 105 may transmit signaling that configures radio resources for the UE 115 during the energy harvesting mode. The UE 115 may indicate to the base station 105 that the UE 115 is transitioning to an energy harvesting mode, and the base station 105 may transmit an indication of a radio resource that is configured for the energy harvesting mode. The UE 115 may also indicate to the base station 105 the rate at which the UE 115 harvests energy and the real-time consumed and harvested power levels.

The UE 115 may communicate with the base station 105 via the configured radio resource during the energy harvesting mode. The UE 115 may operate in an energy harvesting mode while in any RRC state. For example, the UE 115 may operate in an energy harvesting mode in an RRC idle mode, an RRC inactive mode, or an RRC connected mode. The base station 105 may configure the UE 115 to operate with a reduced capability or limited capability radio resource during the energy harvesting mode for power saving purposes. For example, a reduced capability or limited capability radio resource may support intermittent transmission on the UP connection or via the RRC connection with the base station 105.

The base station 105 may also transmit one or more configuration parameters that may trigger the UE 115 to enter the energy harvesting mode (e.g., a battery energy threshold or a battery energy level change amount). The base station 105 k may configure an energy harvesting mode timer which indicates a duration the UE 115 may stay in the energy harvesting mode.

The UE 115 may report its status to the base station 105 when in an energy harvesting mode, for example whether the UE 115 is ready to move out of the energy harvesting mode to a normal capability mode. The UE 115 may transmit, to the base station 105, an indication that the UE 115 is transitioning out of the energy harvesting mode to a normal capability mode (e.g., that energy harvesting is complete), or the UE 115 may transmit an indication that the UE 115 is staying in the energy harvesting mode (e.g., if the battery energy level remains below a threshold), based on the energy harvesting mode timer. If the UE 115 reports that the UE 115 is ready to transition out of the energy harvesting mode to a normal capability mode, the base station 105 may provide a radio resource to the UE 115 configuration for the normal capability mode.

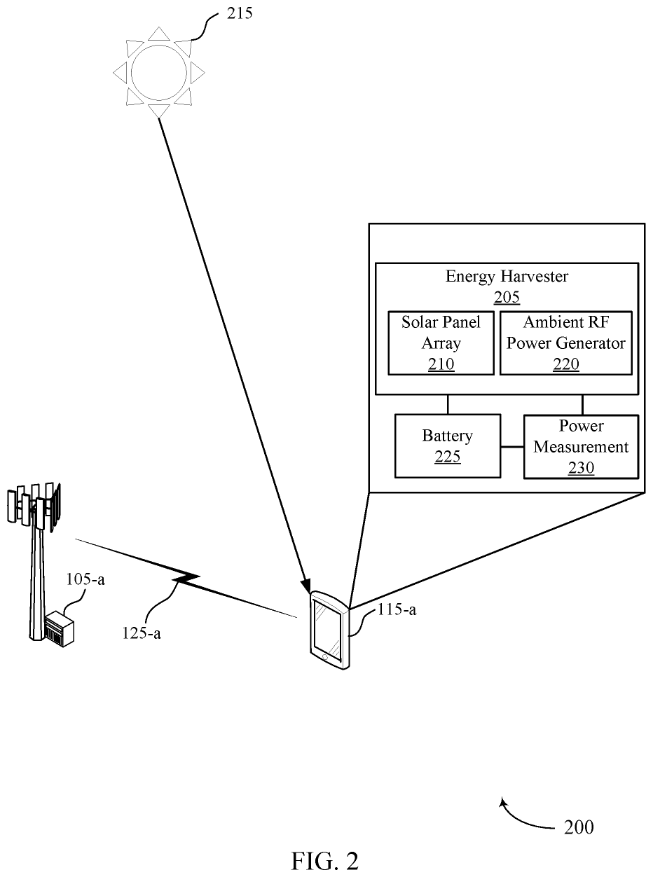

FIG. 2 illustrates an example of a wireless communications system 200 that supports signaling and procedure of energy harvesting indication and energy harvesting mode in accordance with aspects of the present disclosure. The wireless communications system 200 may implement or be implemented to realize aspects of the wireless communications system 100. For example, the wireless communications system 200 illustrates communication between a UE 115-a and a base station 105-a, which may be examples of corresponding devices described herein.

The UE 115-a is configured to harvest energy, for example via energy harvesting circuitry 205. For example, the UE 115-a may include a solar panel array 210 configured to harvest solar energy from the sun 215 or an ambient RF power generator 220 configured to harvest ambient RF radiation (e.g., from signals transmitted by the base station 105-a). The UE 115-a may store harvested energy in a rechargeable battery 225. An amount of energy harvested by the energy harvesting circuitry 205 may vary with time. The UE 115-a communicates with a base station 105-a via a communication link 125-a.

When the UE 115-a is operating in a normal capability mode (e.g., a non-energy harvesting mode) in a non-RRC idle mode (e.g., in an RRC connected mode or an RRC inactive mode), the UE 115-a may measure the energy level of the battery 225 via a real-time technique (e.g., based on the UE 115-a capabilities or implementation). When the UE 115-a is operating in a normal capability mode in a non-RRC idle mode, the UE 115-a may periodically measure the energy level (e.g., via a power measurement engine 230) when the energy level of the UE 115-a (e.g., of the battery 225) is below a configured threshold.

The UE 115-a may transition to an energy harvesting mode based on a trigger (e.g., a triggering condition). In some examples, the base station 105-a may transmit control signaling indicating one or more parameters associated with the trigger (e.g., triggering conditions). In some examples, the base station 105-a may transmit the control signaling indicating the one or more parameters associated with the trigger via dedicated radio resource control signaling or via a system information block.

In some examples, a triggering condition may be a configured energy level threshold (e.g., an absolute energy level threshold). For example, the base station 105-a may indicate an energy level threshold, and if the UE 115-a detects that the energy level of the UE 115-a is below the energy level threshold, the UE 115-a may initiate or trigger transitioning to the energy harvesting mode.

In some examples, a triggering condition may be based on a configured duration threshold and a configured energy level threshold. For example, the base station 105-a may indicate a duration threshold and an energy level threshold. For example, the base station 105-a may configure a time of a given threshold duration. When the energy level of the UE 115-a is below the configured energy level threshold, the UE 115-a may begin a timer. If the energy level exceeds the configured energy level threshold while the timer is running, the UE 115-a may stop the timer. In some examples, if the timer expires (e.g., the timer runs for the threshold duration) and the energy level is below the configured the energy level threshold, the UE 115-a may initiate or trigger transitioning to the energy harvesting mode.

In some examples, a triggering condition may be a configured energy level change threshold. For example, the base station 105-a may indicate an energy level change threshold, and the UE 115-a may determine a measured energy level drifting (e.g., change), and if the energy level drifting is above the threshold level, the UE 115-a may initiate or trigger transitioning to the energy harvesting mode.

If the UE 115-a triggers transitioning the to the energy harvesting mode, the UE 115-a may transmit an indication to the base station 105-a that the UE 115-a is transitioning to the energy harvesting mode. In some examples, the UE 115-a may not transition an RRC state when moving from a normal capability mode to an energy harvesting mode.

If the UE 115-a is in an RRC connected state, the UE 115-a may send a scheduling request to the base station 105-a to request an uplink resource to transmit the indication to the base station 105-a that the UE 115-a is transitioning to the energy harvesting mode. The base station 105-a may transmit a grant for the requested uplink resources in response to the scheduling request, and the UE 115-a may transmit the indication to the base station 105-a that the UE 115-a is transitioning to the energy harvesting mode via the granted uplink resources. If scheduling request resources are not available, the UE 115-a may transmit the indication to the base station 105-a that the UE 115-a is transitioning to the energy harvesting mode in a random access channel procedure. For example, the UE 115-a may trigger a random access channel procedure and the indication that the UE 115-a is transitioning to the energy harvesting mode may be carried in the random access channel procedure.

If the UE 115-a is in an RRC inactive state, and if the UE 115-a does not report a small data transmission (SDT) related capability to the base station 105-a and/or if the base station 105-a does not provide a SDT configuration to the UE 115-a, the UE 115-a may not send an indication to the base station 105-a that the UE 115-a is transitioning to the energy harvesting mode. In such examples, the UE 115-a may be incapable of SDT in the RRC inactive state, and the base station 105-a and UE 115-a may not expect data communications, and thus a radio resource may not be needed for communications between the UE 115-a and the base station 105-a. If the UE 115-a is in an RRC inactive state and if the UE 115-a is capable of SDT and/or the base station 105-a provides an SDT configuration to the UE 115-a, the UE 115-a may leverage the SDT procedure to transmit an indication to the base station 105-a that the UE 115-a is transitioning to the energy harvesting mode.

In some examples, the UE 115-a may maintain a timer (e.g., a prohibit timer) to avoid frequent indications to the base station 105-a that the UE 115-a is transitioning to the energy harvesting mode. For example, the UE 115-a may maintain a timer indicating a duration since a previous transmission by the UE 115-a to the base station 105-a of a previous indication that the UE 115-a is transitioning to the energy harvesting mode. The UE 115-a may not send a subsequent indication to the base station 105-a that the UE 115-a is transitioning to the energy harvesting mode until the timer satisfies a threshold duration.

In some examples, the message transmitted by the UE 115-a indicating to the base station 105-a that the UE 115-a is transitioning to the energy harvesting mode (e.g., the energy harvesting mode indication message) may be transmitted via an RRC message, a MAC control element message, or via reusing the UE assistance information framework.

The energy harvesting indication message may include a timing offset parameter. The timing offset parameter may indicate a configured time offset between the time when the UE 115-a transmits the energy harvesting indication message and a time when the UE 115-a transitions to the energy harvesting mode. The time offset may allow the UE 115-a to complete data exchange with the base station 105-a before transitioning into the energy harvesting mode. In some examples, the base station 105-a may grant sufficient radio resources to the UE 115-a to complete the data exchange in either the uplink or downlink direction before the UE 115-a transitions to the energy harvesting mode. In some examples, the timing offset parameter may be set to 0, meaning that the UE 115-a transitions into the energy harvesting mode upon transmitting the energy harvesting indication message.

In some examples, the energy harvesting indication message may include a duration parameter (e.g., an energy harvesting mode timer) that may indicate a duration that the UE 115-a may stay in the energy harvesting mode. In some examples, the duration parameter may indicate a defined duration (e.g., a minimum duration) that the UE 115-a may stay in the energy harvesting mode. In some examples, the UE 115-a may maintain a timer corresponding to the duration parameter. While the timer corresponding to the duration parameter is running, the UE 115-a may be unable to support frequent data communications with the base station 105-a, and accordingly the base station 105-a may configure radio resources for the UE 115-a during the energy harvesting mode for power saving purposes. The timer corresponding to the duration parameter may restart when the UE 115-a transmits the energy harvesting indication message.

In some examples, the energy harvesting indication message may include a preferred RRC state parameter, which may indicate an RRC state (e.g., RRC idle, RRC inactive, RRC connected, RRC out of connected) that the UE 115-a expects to be in when the UE 115-a transitions out of the energy harvesting mode (e.g., to the normal capability mode). In some examples, the energy harvesting indication message may include an indication of a preferred radio resource (e.g., an index) indicating a target radio resource for the UE 115-a during the energy harvesting mode.

In response to receiving the energy harvesting indication message from the UE 115-a, the base station 105-a may transmit a control message to the UE 115-a indicating a radio resource configuration for the energy harvesting mode.

In some examples, the base station 105-a may transmit a control message reconfiguring the UE 115-a with a reduced capability radio resource for the energy harvesting mode. In some examples, the control message may reuse an RRC reconfiguration message. In some examples, the control message may be transmitted via dedicated RRC signaling.

In some examples, the base station 105-a may transmit, to the UE 115-a, control signaling (e.g., prior to the UE 115-a transmitting the energy harvesting indication message) configuring a set of reduced radio resource configurations for the energy harvesting mode. In some examples, the base station 105-a may transmit the control signaling via RRC signaling. The set of reduced radio resource configurations for the energy harvesting mode may be based on the capabilities of the UE 115-a. In response to receiving the energy harvesting indication message, the base station 105-a may transmit the control message indicating which reduced radio resource configuration of the set of reduced radio resource configurations to activate for the UE 115-a for the energy harvesting mode. In some examples, the base station 105-a may transmit the control message via a MAC control element signal or via a downlink control information signal to select or activate one reduced radio resource configuration among the indicated set of reduced radio resource configurations by control message.

In some examples, the UE 115-a may transmit, to the base station 105-a (e.g., prior to the UE 115-a transmitting the energy harvesting indication message), a message including a capability indicator indicating a reduced capability radio resource configuration of the UE 115-a (e.g., a default radio resource for the energy harvesting mode for the UE 115-a). In response to receiving the energy harvesting indication message, the base station 105-a may transmit the control message to activate the reduced capability radio resource configuration of the UE 115-a for the energy harvesting mode.

In some examples, the base station 105-a may transmit, to the UE 115-a (e.g., prior to the UE 115-a transmitting the energy harvesting indication message), system information indicating a reduced capability radio resource configuration for the UE 115-a. In response to receiving the energy harvesting indication message, the base station 105-a may transmit the control message to activate the reduced capability radio resource configuration of the UE 115-a for the energy harvesting mode.

Before the energy harvesting mode timer (indicated in the energy harvesting indication message) expires, the UE 115-a may indicate to the base station 105-a, for example in a ready for non-energy harvesting mode message, that the UE 115-a is ready to transition out of the energy harvesting mode to a normal capability mode once the UE 115-a completes energy harvesting. In some examples, the ready for non-energy harvesting mode message may be transmitted via an uplink MAC control element message or via a dedicated control channel message. Upon transmission of the ready for non-energy harvesting mode message, the UE 115-a may stop the energy harvesting mode timer.

In some examples, if the UE 115-a is in an RRC connected state, the UE 115-a may send a scheduling request to the base station 105-a to request an uplink resource to transmit the ready for non-energy harvesting mode message to the base station 105-a. The base station 105-a may transmit a grant for the requested uplink resources in response to the scheduling request, and the UE 115-a may transmit the ready for non-energy harvesting mode message to the base station 105-a via the granted uplink resources. If scheduling request resources are not available, the UE 115-a may transmit the ready for non-energy harvesting mode message to the base station 105-a in a random access channel procedure.

In some examples, if the UE 115-a is in an RRC inactive state and if the UE 115-a is capable of SDT and/or the base station 105-a provides an SDT configuration to the UE 115-a, the UE 115-a may leverage the SDT procedure to transmit the ready for non-energy harvesting mode message to the base station 105-a.

In some examples, if the base station 105-a receives the ready for non-energy harvesting mode message before the energy harvesting mode time stops, the base station 105-a may transmit a control message indicating a radio resource configuration for the UE 115-a during the normal capability mode. In some examples, the base station 105-a may transmit the control message via a MAC control element message, a downlink control information message, an RRC reconfiguration message, or an RRC message.

In some examples, the UE 115-a may indicate the energy status of the UE 115-a to the base station 105-a if the UE 115-a has not completed energy harvesting when the energy harvesting timer expires. In some examples, the UE 115-a may transmit another energy harvesting indication message to the base station 105-a, which may restart the energy harvesting timer. In some examples, the UE 115-a may transmit, upon the expiration of the energy harvesting timer, a message including a flag indicating whether the UE 115-a is ready to transition out of the energy harvesting mode to the normal capability mode. For example, the UE 115-a may turn the flag off in the message to indicate that the UE 115-a is not ready to transition out of the energy harvesting mode to the normal capability mode, and the UE 115-a may turn the flag on in the message to indicate that the UE 115-a is ready to transition out of the energy harvesting mode to the normal capability mode. In some examples, the UE 115-a may restart the energy harvesting timer upon transmission of either another energy harvesting indication message to the base station 105-a or transmission of a message indicating that the UE 115-a is not ready to transition out of the energy harvesting mode to the normal capability mode.

In some examples, the UE 115-a may maintain a prohibit timer indicating a duration since a previous transmission of a ready for non-energy harvesting mode message to avoid frequent indications to the base station 105-a that the UE 115-a is transitioning out of the energy harvesting mode or staying in the energy harvesting mode. For example, the UE 115-a may maintain a timer indicating a duration since a previous transmission by the UE 115-a to the base station 105-a of a previous ready for non-energy harvesting mode message. The UE 115-a may not send a subsequent ready for non-energy harvesting mode message to the base station 105-a until the timer satisfies a threshold duration.

In some examples, when the base station 105-a receives a ready for non-energy harvesting mode message from the UE 115-a, the base station 105-a may configure a radio resource for the UE 115-a for the normal capability mode. In some examples, if the energy harvesting timer expires and the base station 105-a does not receive a ready for non-energy harvesting mode message, the base station 105-a may transmit control signaling to the UE 115-a indicating for the UE 115-a to enter an idle mode. For example, the base station 105-a may assume that the UE 115-a lost power or has insufficient power to sustain communications with the base station 105-a. In some examples, the base station 105-a may transmit the control signaling indicating for the UE 115-a to enter an idle mode via an RRC message.

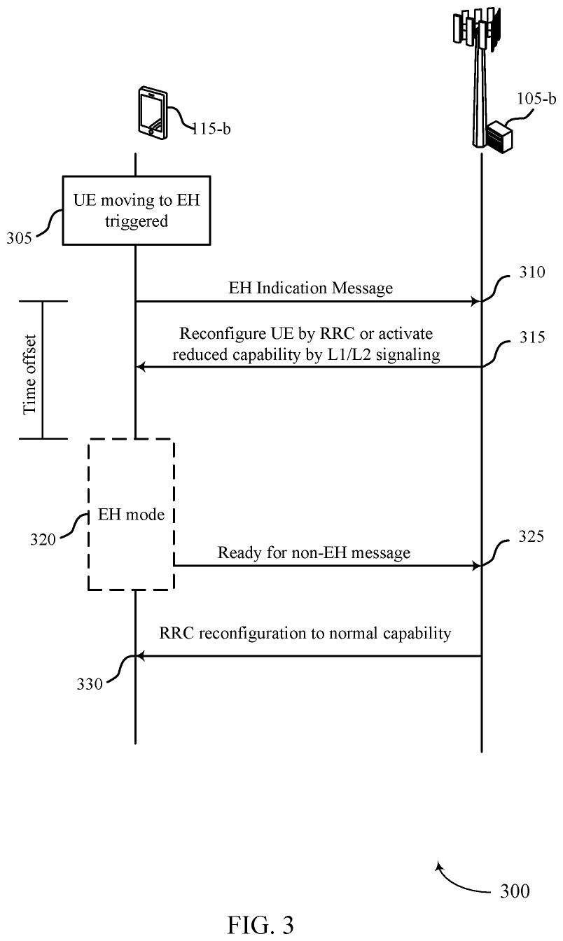

FIG. 3 illustrates an example of a process flow 300 that supports signaling and procedure of energy harvesting indication and energy harvesting mode in accordance with aspects of the present disclosure. Process flow 300 may implement aspects of or may be implemented by aspects of wireless communications systems 100 or 200. For example, base station 105-b may be an example of a base station 105 as described herein, and UE 115-b may be an example of a UE 115 as described herein.

At 305, the UE 115-b may determine that a transition to an energy harvesting mode has been triggered. In some examples, the base station 105-b may transmit control signaling indicating one or more parameters associated with triggering the UE 115-b to transition to the energy harvesting mode (e.g., triggering conditions). In some examples, the base station 105-b may transmit the control signaling indicating the one or more parameters associated with the trigger via dedicated radio resource control signaling or via a system information block. At 305, the UE 115-b may determine that one or more of the triggering conditions has been satisfied.

At 310, the UE 115-b transmits, to the base station 105-b a message indicating to the base station 105-b that the UE 115-b is transitioning to the energy harvesting mode. In some examples, the message transmitted by the UE 115-b indicating to the base station 105-b that the UE 115-b is transitioning to the energy harvesting mode (e.g., the energy harvesting mode indication message) may be transmitted via an RRC message, a MAC control element message, or via reusing the UE assistance information framework.

The energy harvesting indication message may include a timing offset parameter. The timing offset parameter may indicate a configured time offset between the time when the UE 115-b transmits the energy harvesting indication message and a time when the UE 115-b transitions to the energy harvesting mode. The time offset may allow the UE 115-b to complete data exchange with the base station 105-b before transitioning into the energy harvesting mode. In some examples, the base station 105-b may grant sufficient radio resources to the UE 115-b to complete the data exchange in either the uplink or downlink direction before the UE 115-b transitions to the energy harvesting mode. In some examples, the timing offset parameter may be set to 0, meaning that the UE 115-b transitions into the energy harvesting mode upon transmitting the energy harvesting indication message.

In some examples, the energy harvesting indication message may include a duration parameter (e.g., an energy harvesting mode timer) that may indicate a duration that the UE 115-b may stay in the energy harvesting mode. In some examples, the duration parameter may indicate a minimum duration that the UE 115-b may stay in the energy harvesting mode. In some examples, the UE 115-b may maintain a timer corresponding to the duration parameter. While the timer corresponding to the duration parameter is running, the UE 115-b may be unable to support frequent data communications with the base station 105-b, and accordingly the base station 105-b may configure radio resources for the UE 115-b during the energy harvesting mode for power saving purposes. The timer corresponding to the duration parameter may restart when the UE 115-b transmits the energy harvesting indication message.

In some examples, the energy harvesting indication message may include a preferred RRC state parameter, which may indicate an RRC state (e.g., RRC idle, RRC inactive, RRC connected, RRC out of connected) that the UE 115-b expects to be in when the UE 115-b transitions out of the energy harvesting mode (e.g., to the normal capability mode). In some examples, the energy harvesting indication message may include an indication of a preferred radio resource (e.g., an index) indicating a target radio resource for the UE during the energy harvesting mode.

At 315, in response to receiving the energy harvesting indication message from the UE 115-b at 310, the base station 105-b transmits a control message to the UE 115-b indicating a radio resource configuration for the energy harvesting mode. The radio resource configuration may indicate one or more parameters the UE 115-b is to apply while in the energy harvesting mode, including an RRC state (e.g., idle, inactive, connected, outOfConnected, etc.), a radio resource (e.g., bandwidth part, frequency band, etc.) for communicating with the base station 105-b during the energy harvesting mode (e.g., ready to transition from energy harvesting mode to non-energy harvesting mode, restarting energy harvesting mode timer, etc.), as described herein. The radio resource configuration may also be referred to herein as a reduced radio resource configuration.

In some examples, the base station 105-b may transmit a control message reconfiguring the UE 115-b with a reduced capability radio resource for the energy harvesting mode. In some examples, the control message may reuse an RRC reconfiguration message. In some examples, the control message may be transmitted via dedicated RRC signaling.

In some examples, the base station 105-b may transmit, to the UE 115-b, control signaling (e.g., prior to the UE 115-b transmitting the energy harvesting indication message) configuring a set of reduced radio resource configurations for the energy harvesting mode. In some examples, the base station 105-b may transmit the control signaling via RRC signaling. The set of reduced radio resource configurations for the energy harvesting mode may be based on the capabilities of the UE 115-b. In response to receiving the energy harvesting indication message, the base station 105-b may transmit the control message indicating which reduced radio resource configuration of the set of reduced radio resource configurations to activate for the UE 115-b for the energy harvesting mode. In some examples, the base station 105-b may transmit the control message via a MAC control element signal or via a downlink control information signal to select or activate one reduced radio resource configuration among the indicated set of reduced radio resource configurations by control message.

In some examples, the UE 115-b may transmit, to the base station 105-b (e.g., prior to the UE 115-b transmitting the energy harvesting indication message), a message including a capability indicator indicating a reduced capability radio resource configuration of the UE 115-b (e.g., a default radio resource for the energy harvesting mode for the UE 115-b). In response to receiving the energy harvesting indication message, the base station 105-b may transmit the control message to activate the reduced capability radio resource configuration of the UE 115-b for the energy harvesting mode.

In some examples, the base station 105-b may transmit, to the UE 115-b (e.g., prior to the UE 115-b transmitting the energy harvesting indication message), system information indicating a reduced capability radio resource configuration for the UE 115-b. In response to receiving the energy harvesting indication message, the base station 105-b may transmit the control message to activate the reduced capability radio resource configuration of the UE 115-b for the energy harvesting mode.

At 320, the UE 115-b transitions to the energy harvesting mode. The timing offset between the UE 115-b transitioning to the energy harvesting mode at 320 transmitting energy harvesting mode indication message at 310 may be indicated in the timing offset parameter of the energy harvesting mode indication message.

At 325, the UE 115-b transmits a ready for non-energy harvesting mode message to the base station 105-b. In some examples, the UE 115-b may transmit a ready for non-energy harvesting mode message prior to the expiration of the energy harvesting mode timer, for example if the UE 115-b determines that an energy level of the UE 115-b is above a threshold. In some examples, the UE 115-b may transmit the ready for non-energy harvesting mode message at the expiration of the energy harvesting mode timer. The ready for non-energy harvesting mode message may be transmitted via an uplink MAC control element message or via a dedicated control channel message. In some examples, upon transmission of the ready for non-energy harvesting mode message, the UE 115-b may stop the energy harvesting mode timer.

In some examples, if the UE 115-b is in an RRC connected state, the UE 115-b may send a scheduling request to the base station 105-b to request an uplink resource to transmit the ready for non-energy harvesting mode message to the base station 105-b. The base station 105-b may transmit a grant for the requested uplink resources in response to the scheduling request, and the UE 115-b may transmit the ready for non-energy harvesting mode message to the base station 105-b via the granted uplink resources. If scheduling request resources are not available, the UE 115-b may transmit the ready for non-energy harvesting mode message to the base station 105-b in a random access channel procedure.

In some examples, if the UE 115-b is in an RRC inactive state and if the UE 115-b is capable of SDT and/or the base station 105-b provides an SDT configuration to the UE 115-b, the UE 115-b may leverage the SDT procedure to transmit the ready for non-energy harvesting mode message to the base station 105-b.

At 330, in response to receiving the ready for non-energy harvesting mode message, the base station 105-b transmits a control message indicating a radio resource configuration for the UE 115-b during the normal capability mode. In some examples, the base station 105-b may transmit the control message via a MAC control element message, a downlink control information message, an RRC reconfiguration message, or an RRC message. The UE 115-b may communicate with the base station 105-b in the normal capability mode using the indicated radio resource configuration for the UE 115-b during the normal capability mode.

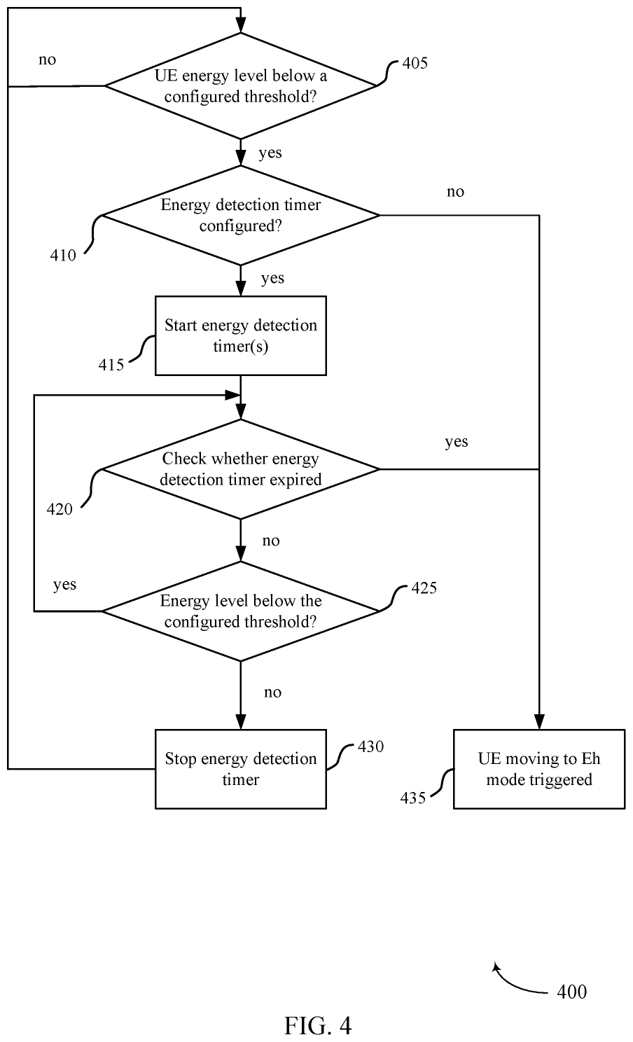

FIG. 4 illustrates an example of a process flow 400 that supports signaling and procedure of energy harvesting indication and energy harvesting mode in accordance with aspects of the present disclosure. Process flow 400 may implement aspects of or may be implemented by aspects of wireless communications systems 100 or 200.

In some examples, a base station 105 may transmit control signaling indicating one or more parameters associated with triggering a UE 115 to transition to an energy harvesting mode (e.g., triggering conditions). For example, the base station 105 may indicate an energy level threshold and/or a duration threshold.

At 405, the UE 115 determines whether the energy level of the UE 115 is below the configured threshold received from the base station 105. If the energy level of the UE 115 is not below the configured threshold (405), the UE 115 continues to check at 405 whether the energy level of the UE 115 is below the configured threshold. If the energy level of the UE 115 is below the configured threshold (405), at 410, the UE 115 checks whether an energy detection timer (e.g., a duration threshold) is configured. If an energy detection timer (e.g., a duration threshold) is not configured (e.g., not received via control signaling from the base station 105) (410), at 435 the UE 115 triggers transitioning to the energy harvesting mode. If an energy detection timer (e.g., a duration threshold) is configured (410), then at 415 the UE 115 starts the energy detection timer. At 420, the UE 115 checks whether the energy detection timer has expired (e.g., whether the energy detection timer has reached the configured duration threshold). If the energy detection timer has expired (420) and the energy level of the UE 115 is still below the configured threshold, at 435 the UE 115 triggers transitioning to the energy harvesting mode. If the energy detection timer has not expired (420), at 425 the UE 115 checks whether the energy level of the UE 115 is below the configured threshold. If the energy level of the UE 115 is below the configured threshold (425), the UE 115 returns to 420 and checks whether the energy detection timer has expired. If the energy level of the UE 115 is not below the configured threshold (425), at 430 the UE 115 stops the energy detection timer and returns to 405.

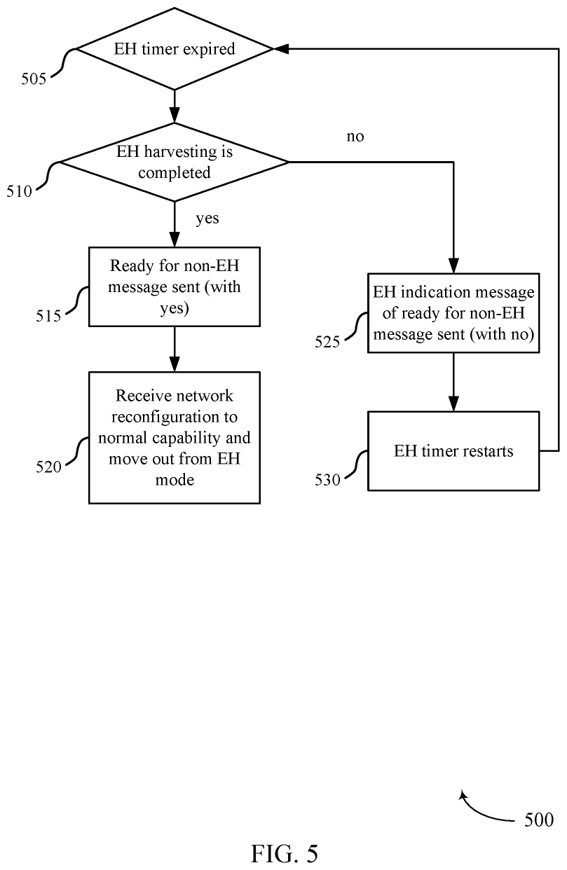

FIG. 5 illustrates an example of a process flow 500 that supports signaling and procedure of energy harvesting indication and energy harvesting mode in accordance with aspects of the present disclosure. Process flow 500 may implement aspects of or may be implemented by aspects of wireless communications systems 100 or 200.

At 505, a UE 115 operating in an energy harvesting mode determines that an energy harvesting timer has expired. The UE 115 may receive, from a base station 105, an energy harvesting timer parameter via control signaling, where the energy harvesting timer corresponds to a duration which the UE 115 may stay in an energy harvesting mode. At 510, the UE 115 checks whether energy harvesting is complete (e.g., whether an energy level of the UE 115 is above a configured threshold).

If the UE 115 determines that energy harvesting is complete (510), then the UE 115 transmits, at 515, a ready for non-energy harvesting message to the base station 105. In some examples, the UE 115 may transmit, at 515 a message including a flag indicating the UE 115 is ready to transition out of the energy harvesting mode to the normal capability mode. For example, the UE 115 may turn the flag on in the message to indicate that the UE 115 is ready to transition out of the energy harvesting mode to the normal capability mode. At 520, in response to receiving the ready for non-energy harvesting message, the base station 105 may transmit, to the UE 115, a radio resource configuration for the UE 115 for the normal capability mode, and the UE 115 may transition out of the energy harvesting mode to the normal capability mode.

If the UE 115 determines that energy harvesting is not complete (510), then the UE 115 transmits, at 525, a message indicating to the base station 105 that the UE 115 is not ready to transition out of the energy harvesting mode. For example, the UE 115 may turn the flag off in a ready for non-energy harvesting message to indicate that the UE 115 is not ready to transition out of the energy harvesting mode to the normal capability mode. At 530, the UE 115 remains in the energy harvesting mode and the energy harvesting timer restarts.

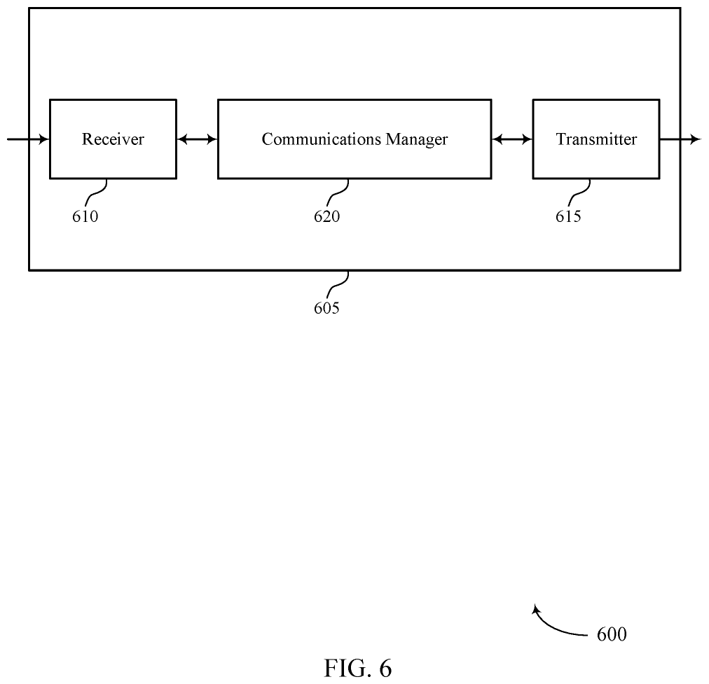

FIG. 6 shows a diagram 600 of a device 605 that supports signaling and procedure of energy harvesting indication and energy harvesting mode in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling and procedure of energy harvesting indication and energy harvesting mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling and procedure of energy harvesting indication and energy harvesting mode). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of signaling and procedure of energy harvesting indication and energy harvesting mode as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for transmitting, to a base station, an indication that the UE is transitioning to an energy harvesting mode based on a trigger, and a timing offset parameter indicating a timing offset between transmission of the indication and transitioning to the energy harvesting mode. The communications manager 620 may be configured as or otherwise support a means for receiving, from the base station, a control message indicating a radio resource configuration for the energy harvesting mode, prior to transitioning to the energy harvesting mode. The communications manager 620 may be configured as or otherwise support a means for transitioning to the energy harvesting mode in accordance with the timing offset parameter.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced power consumption and more efficient utilization of communication resources, for example by signaling an indication that the UE 115 is transitioning into an energy harvesting mode, and receiving, in response, a radio resource configuration for the energy harvesting mode.

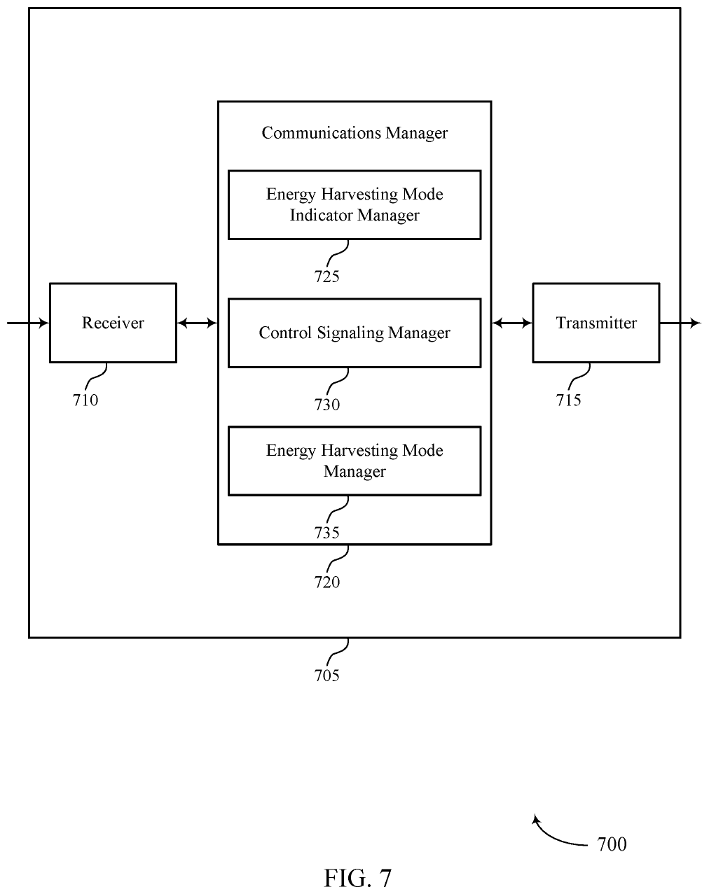

FIG. 7 shows a diagram 700 of a device 705 that supports signaling and procedure of energy harvesting indication and energy harvesting mode in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling and procedure of energy harvesting indication and energy harvesting mode). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling and procedure of energy harvesting indication and energy harvesting mode). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling and procedure of energy harvesting indication and energy harvesting mode as described herein. For example, the communications manager 720 may include an energy harvesting mode indicator manager 725, a control signaling manager 730, an energy harvesting mode manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The energy harvesting mode indicator manager 725 may be configured as or otherwise support a means for transmitting, to a base station, an indication that the UE is transitioning to an energy harvesting mode based on a trigger, and a timing offset parameter indicating a timing offset between transmission of the indication and transitioning to the energy harvesting mode. The control signaling manager 730 may be configured as or otherwise support a means for receiving, from the base station, a control message indicating a radio resource configuration for the energy harvesting mode, prior to transitioning to the energy harvesting mode. The energy harvesting mode manager 735 may be configured as or otherwise support a means for transitioning to the energy harvesting mode in accordance with the timing offset parameter.

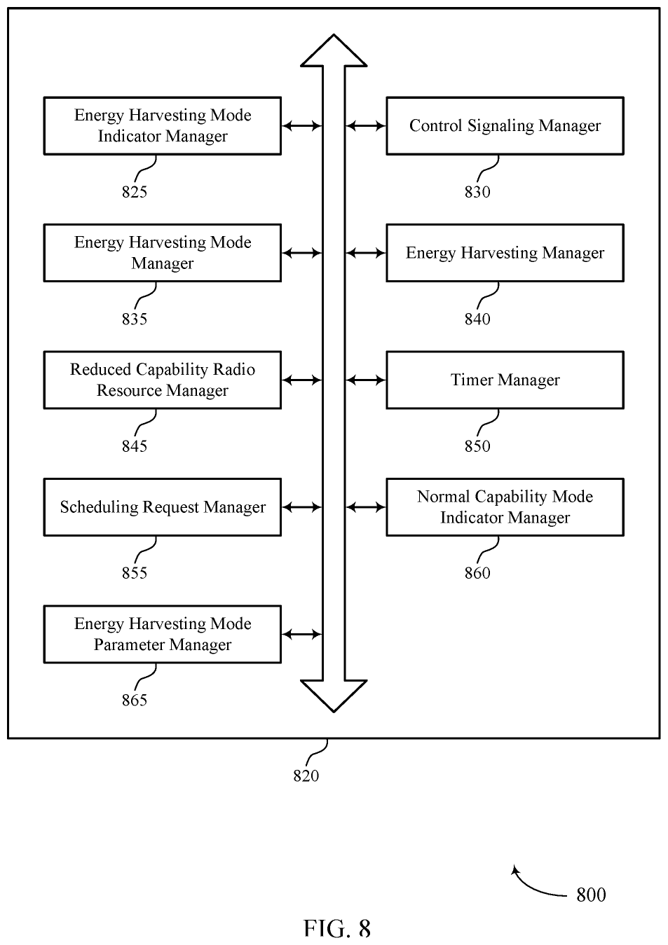

FIG. 8 shows a diagram 800 of a communications manager 820 that supports signaling and procedure of energy harvesting indication and energy harvesting mode in accordance with aspects of the present disclosure. The communications manager 820 may be an example of aspects of a communications manager 620, a communications manager 720, or both, as described herein. The communications manager 820, or various components thereof, may be an example of means for performing various aspects of signaling and procedure of energy harvesting indication and energy harvesting mode as described herein. For example, the communications manager 820 may include an energy harvesting mode indicator manager 825, a control signaling manager 830, an energy harvesting mode manager 835, an energy harvesting manager 840, a reduced capability radio resource manager 845, a timer manager 850, a scheduling request manager 855, a normal capability mode indicator manager 860, an energy harvesting mode parameter manager 865, or any combination thereof. Each of these components may communicate, directly or indirectly, with one another (e.g., via one or more buses).

The communications manager 820 may support wireless communications at a UE in accordance with examples as disclosed herein. The energy harvesting mode indicator manager 825 may be configured as or otherwise support a means for transmitting, to a base station, an indication that the UE is transitioning to an energy harvesting mode based on a trigger, and a timing offset parameter indicating a timing offset between transmission of the indication and transitioning to the energy harvesting mode. The control signaling manager 830 may be configured as or otherwise support a means for receiving, from the base station, a control message indicating a radio resource configuration for the energy harvesting mode, prior to transitioning to the energy harvesting mode. The energy harvesting mode manager 835 may be configured as or otherwise support a means for transitioning to the energy harvesting mode in accordance with the timing offset parameter.

In some examples, the energy harvesting manager 840 may be configured as or otherwise support a means for performing energy harvesting when the UE is in a radio resource control idle mode, a radio resource control inactive mode, or a radio resource control connected mode.

In some examples, the reduced capability radio resource manager 845 may be configured as or otherwise support a means for communicating with the base station using the radio resource configuration during the energy harvesting mode.

In some examples, the timer manager 850 may be configured as or otherwise support a means for maintaining a timer indicating a duration since a previous transmission by the UE of a previous indication that the UE is transitioning to the energy harvesting mode, where transmitting the indication is based on the timer exceeding a threshold duration.

In some examples, the control signaling manager 830 may be configured as or otherwise support a means for receiving, from the base station, control signaling indicating one or more parameters associated with the trigger, where the transmitting the indication that the UE is transitioning to the energy harvesting mode is based on the control signaling.

In some examples, to support receiving the control signaling, the control signaling manager 830 may be configured as or otherwise support a means for receiving the control signaling via dedicated radio resource control signaling or a system information block.

In some examples, the one or more parameters includes an energy level threshold. In some examples, the trigger is based on an energy level being below the energy level threshold.

In some examples, the one or more parameters includes an energy level threshold and a duration threshold. In some examples, the trigger is based on an energy level of the UE being below the energy level threshold for at least the duration threshold.

In some examples, the one or more parameters includes an energy level change threshold. In some examples, the trigger is based on a change in an energy level of the UE exceeding the energy level change threshold.

In some examples, the scheduling request manager 855 may be configured as or otherwise support a means for transmitting, to the base station, a scheduling request for an uplink resource. In some examples, the energy harvesting mode indicator manager 825 may be configured as or otherwise support a means for receiving, from the base station, a grant for the uplink resource based on the scheduling request, and where transmitting the indication that the UE is transitioning to the energy harvesting mode includes transmitting the indication via the uplink resource.

In some examples, to support transmitting the indication that the UE is transitioning to the energy harvesting mode, the energy harvesting mode indicator manager 825 may be configured as or otherwise support a means for transmitting the indication in a random access channel procedure based on the control signaling.

In some examples, to support transmitting the indication that the UE is transitioning to the energy harvesting mode, the energy harvesting mode indicator manager 825 may be configured as or otherwise support a means for transmitting the indication via a small data transmission.

In some examples, to support transmitting the indication, the energy harvesting mode indicator manager 825 may be configured as or otherwise support a means for transmitting: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

In some examples, the timer manager 850 may be configured as or otherwise support a means for restarting a timer associated with the timer parameter based on receiving the control message from the base station.

In some examples, to support receiving the control message, the reduced capability radio resource manager 845 may be configured as or otherwise support a means for receiving a second indication of a reduced capability radio resource configuration for the energy harvesting mode.

In some examples, the reduced capability radio resource manager 845 may be configured as or otherwise support a means for receiving, from the base station, control signaling indicating a set of multiple reduced radio resource configurations, and where receiving the control message includes receiving a second indication of a reduced capability radio resource configuration of the set of multiple reduced radio resource configurations.

In some examples, to support receiving the control signaling, the control signaling manager 830 may be configured as or otherwise support a means for receiving the control signaling via a radio resource control signal, where receiving the second indication includes. In some examples, to support receiving the control signaling, the control signaling manager 830 may be configured as or otherwise support a means for receiving the second indication via a medium access control control element signal or via a downlink control information signal.

In some examples, the reduced capability radio resource manager 845 may be configured as or otherwise support a means for transmitting, to the base station, a capability indicator indicating a reduced capability radio resource configuration of the UE, where receiving the control message includes receiving a second indication to activate the reduced capability radio resource configuration of the UE for the energy harvesting mode based on the capability indicator.

In some examples, the reduced capability radio resource manager 845 may be configured as or otherwise support a means for receiving system information indicating a reduced capability radio resource configuration for the UE, where receiving the control signaling includes receiving a second indication to activate the reduced capability radio resource configuration of the UE for the energy harvesting mode.

In some examples, the normal capability mode indicator manager 860 may be configured as or otherwise support a means for transmitting, to the base station, a second indication that the UE is transitioning out of the energy harvesting mode to a normal capability mode.

In some examples, the control signaling manager 830 may be configured as or otherwise support a means for receiving, from the base station, a second control message indicating a second radio resource configuration for the UE during the normal capability mode.

In some examples, the timer manager 850 may be configured as or otherwise support a means for maintaining a timer indicating a duration since a previous transmission by the UE of a previous indication that the UE is transitioning out of the energy harvesting mode to the normal capability mode, where transmitting the indication is based on the timer exceeding a threshold duration.

In some examples, to support transmitting the second indication that the UE is transitioning out of the energy harvesting mode to the normal capability mode, the normal capability mode indicator manager 860 may be configured as or otherwise support a means for transmitting the second indication via a medium access control control element message or a radio resource control message.

In some examples, the energy harvesting mode indicator manager 825 may be configured as or otherwise support a means for transmitting, to the base station, the indication or a second indication that the UE is extending a duration of the energy harvesting mode.

In some examples, to support transmitting the indication or the second indication that the UE is extending the duration of the energy harvesting mode, the energy harvesting mode indicator manager 825 may be configured as or otherwise support a means for transmitting the indication or the second indication via a medium access control control element message or a radio resource control message.

In some examples, the control signaling manager 830 may be configured as or otherwise support a means for receiving, from the base station, control signaling indicating for the UE to enter an idle mode, where the control signaling is based on a duration of the energy harvesting mode.

In some examples, to support receiving the control signaling, the control signaling manager 830 may be configured as or otherwise support a means for receiving the control signaling via a medium access control control element message or a radio resource control message.

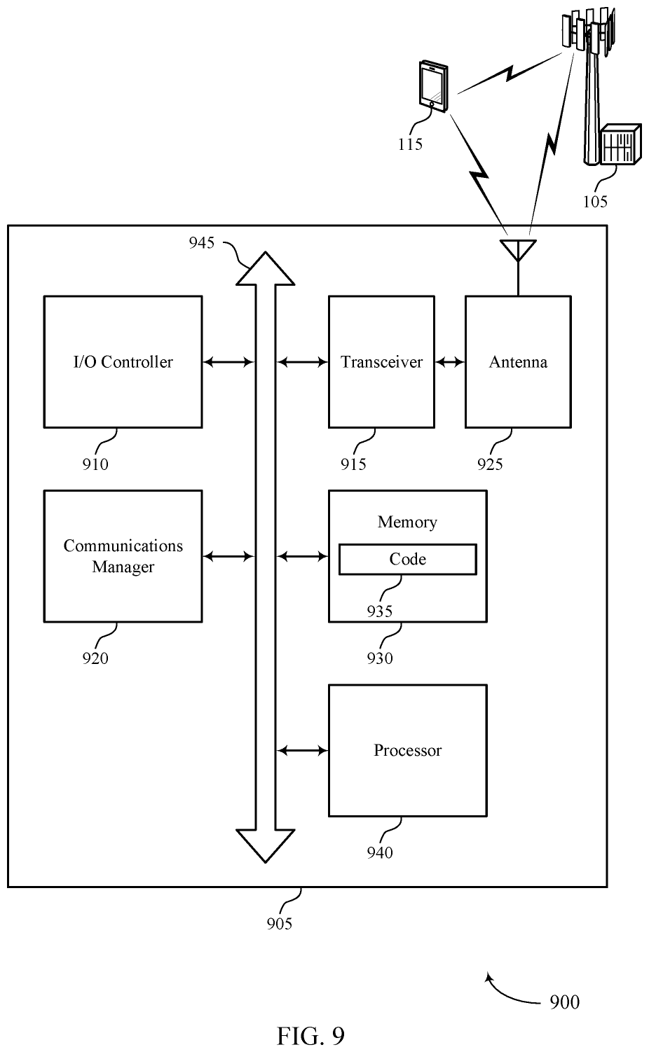

FIG. 9 shows a diagram of a system 900 including a device 905 that supports signaling and procedure of energy harvesting indication and energy harvesting mode in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting signaling and procedure of energy harvesting indication and energy harvesting mode). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting, to a base station, an indication that the UE is transitioning to an energy harvesting mode based on a trigger, and a timing offset parameter indicating a timing offset between transmission of the indication and transitioning to the energy harvesting mode. The communications manager 920 may be configured as or otherwise support a means for receiving, from the base station, a control message indicating a radio resource configuration for the energy harvesting mode, prior to transitioning to the energy harvesting mode. The communications manager 920 may be configured as or otherwise support a means for transitioning to the energy harvesting mode in accordance with the timing offset parameter.

By including or configuring the communications manager 920 in accordance with examples as described herein, the device 905 may support techniques for reduced power consumption, more efficient utilization of communication resources, for example by signaling an indication that the UE 115 is transitioning into an energy harvesting mode, and receiving, in response, a radio resource configuration for the energy harvesting mode.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of signaling and procedure of energy harvesting indication and energy harvesting mode as described herein, or the processor 940 and the memory 930 may be otherwise configured to perform or support such operations.

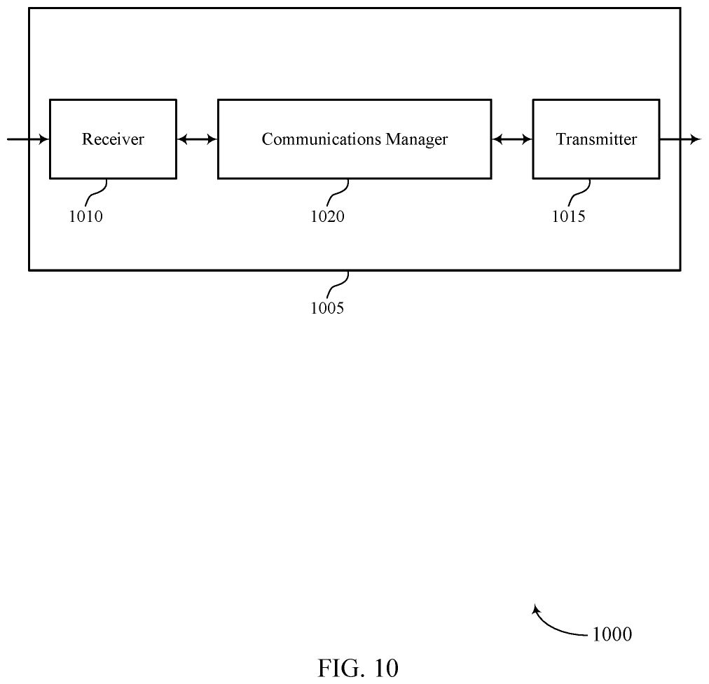

FIG. 10 shows a diagram 1000 of a device 1005 that supports signaling and procedure of energy harvesting indication and energy harvesting mode in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to signaling and procedure of energy harvesting indication and energy harvesting mode). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to signaling and procedure of energy harvesting indication and energy harvesting mode). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of signaling and procedure of energy harvesting indication and energy harvesting mode as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for receiving, from a UE, an indication that the UE is transitioning to an energy harvesting mode based on a trigger, and a timing offset parameter indicating a timing offset between transmission of the indication and transitioning to the energy harvesting mode. The communications manager 1020 may be configured as or otherwise support a means for transmitting, to the UE, a control message indicating a radio resource configuration for the energy harvesting mode, prior to the UE transitioning to the energy harvesting mode. The communications manager 1020 may be configured as or otherwise support a means for communicating with the UE using the radio resource configuration during the energy harvesting mode.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced power consumption and more efficient utilization of communication resources, for example by receiving signaling indicating that a UE 115 is transitioning into an energy harvesting mode, and transmitting, to the UE 115, in response, a radio resource configuration for the energy harvesting mode.

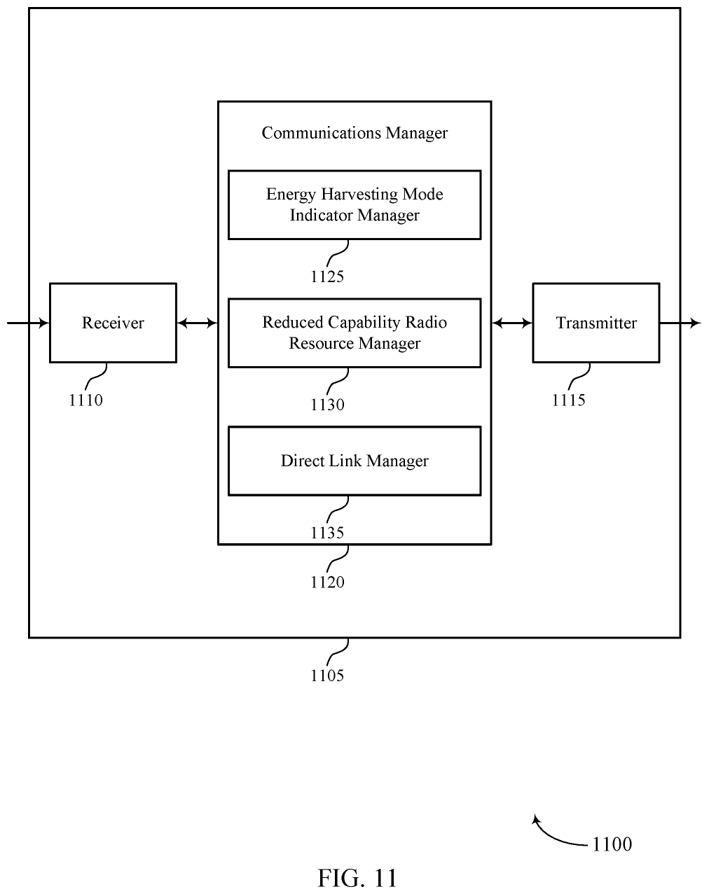

FIG. 11 shows a diagram 1100 of a device 1105 that supports signaling and procedure of energy harvesting indication and energy harvesting mode in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to signaling and procedure of energy harvesting indication and energy harvesting mode). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to signaling and procedure of energy harvesting indication and energy harvesting mode). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of signaling and procedure of energy harvesting indication and energy harvesting mode as described herein. For example, the communications manager 1120 may include an energy harvesting mode indicator manager 1125, a reduced capability radio resource manager 1130, a direct link manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The energy harvesting mode indicator manager 1125 may be configured as or otherwise support a means for receiving, from a UE, an indication that the UE is transitioning to an energy harvesting mode based on a trigger, and a timing offset parameter indicating a timing offset between transmission of the indication and transitioning to the energy harvesting mode. The reduced capability radio resource manager 1130 may be configured as or otherwise support a means for transmitting, to the UE, a control message indicating a radio resource configuration for the energy harvesting mode, prior to the UE transitioning to the energy harvesting mode. The direct link manager 1135 may be configured as or otherwise support a means for communicating with the UE using the radio resource configuration during the energy harvesting mode.

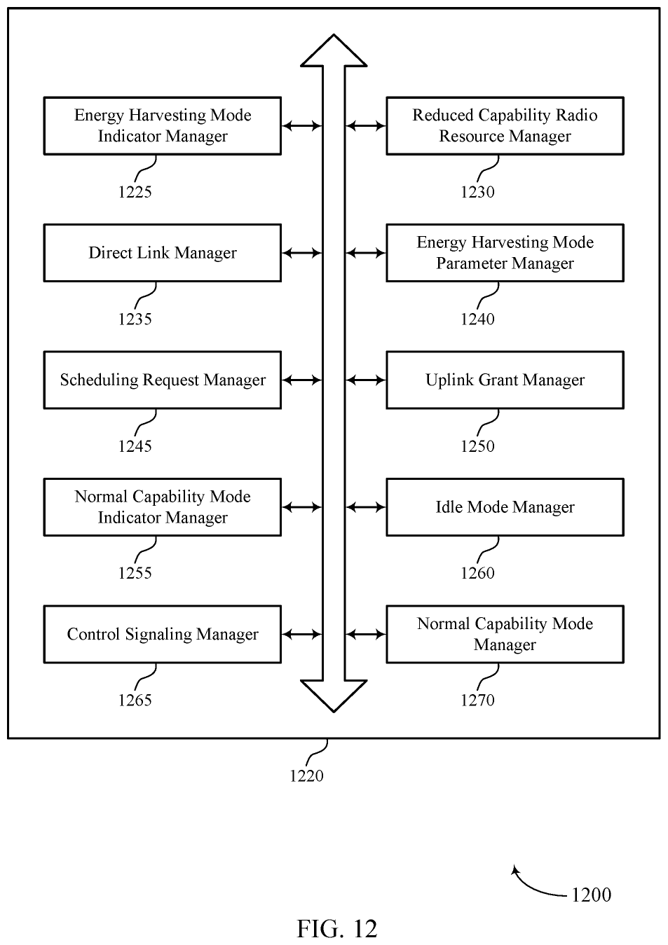

FIG. 12 shows a diagram 1200 of a communications manager 1220 that supports signaling and procedure of energy harvesting indication and energy harvesting mode in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of signaling and procedure of energy harvesting indication and energy harvesting mode as described herein. For example, the communications manager 1220 may include an energy harvesting mode indicator manager 1225, a reduced capability radio resource manager 1230, a direct link manager 1235, an energy harvesting mode parameter manager 1240, a scheduling request manager 1245, an uplink grant manager 1250, a normal capability mode indicator manager 1255, an idle mode manager 1260, a control signaling manager 1265, a normal capability mode manager 1270, or any combination thereof. Each of these components may communicate, directly or indirectly, with one another (e.g., via one or more buses).

The communications manager 1220 may support wireless communications at a base station in accordance with examples as disclosed herein. The energy harvesting mode indicator manager 1225 may be configured as or otherwise support a means for receiving, from a UE, an indication that the UE is transitioning to an energy harvesting mode based on a trigger, and a timing offset parameter indicating a timing offset between transmission of the indication and transitioning to the energy harvesting mode. The reduced capability radio resource manager 1230 may be configured as or otherwise support a means for transmitting, to the UE, a control message indicating a radio resource configuration for the energy harvesting mode, prior to the UE transitioning to the energy harvesting mode. The direct link manager 1235 may be configured as or otherwise support a means for communicating with the UE using the radio resource configuration during the energy harvesting mode.

In some examples, the energy harvesting mode parameter manager 1240 may be configured as or otherwise support a means for transmitting, to the UE, control signaling indicating one or more parameters associated with triggering transitioning to the energy harvesting mode, where the receiving the indication that the UE is transitioning to the energy harvesting mode is based on the control signaling.

In some examples, to support transmitting the control signaling, the control signaling manager 1265 may be configured as or otherwise support a means for transmitting the control signaling via dedicated radio resource control signaling or a system information block.

In some examples, the one or more parameters includes an energy level threshold, and the trigger is based on an energy level being below the energy level threshold.

In some examples, the one or more parameters includes an energy level threshold and a duration threshold, the trigger is based on an energy level of the UE being below the energy level threshold for at least the duration threshold.

In some examples, the one or more parameters includes an energy level change threshold, the trigger is based on a change in an energy level of the UE exceeding the energy level change threshold.

In some examples, the scheduling request manager 1245 may be configured as or otherwise support a means for receiving, from the UE, a scheduling request for an uplink resource. In some examples, the uplink grant manager 1250 may be configured as or otherwise support a means for transmitting, to the UE, a grant for the uplink resource based on the scheduling request, and where receiving the indication that the UE is transitioning to the energy harvesting mode includes receiving the indication via the uplink resource.

In some examples, to support receiving the indication that the UE is transitioning to the energy harvesting mode, the energy harvesting mode indicator manager 1225 may be configured as or otherwise support a means for receiving the indication in a random access channel procedure based on the control signaling.

In some examples, to support receiving the indication that the UE is transitioning to the energy harvesting mode, the energy harvesting mode indicator manager 1225 may be configured as or otherwise support a means for receiving the indication via a small data transmission.

In some examples, to support receiving the indication, the energy harvesting mode indicator manager 1225 may be configured as or otherwise support a means for receiving: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

In some examples, to support transmitting the control message, the reduced capability radio resource manager 1230 may be configured as or otherwise support a means for transmitting a second indication of a reduced capability radio resource configuration for the UE during the energy harvesting mode.

In some examples, the reduced capability radio resource manager 1230 may be configured as or otherwise support a means for transmitting, to the UE, control signaling indicating a set of multiple reduced radio resource configurations, and where transmitting the control message includes transmitting a second indication of a reduced capability radio resource configuration of the set of multiple reduced radio resource configurations.

In some examples, to support transmitting the control signaling, the control signaling manager 1265 may be configured as or otherwise support a means for transmitting the control signaling via a radio resource control signal, and where transmitting the second indication includes transmitting the second indication via a medium access control control element signal or via a downlink control information signal.

In some examples, the reduced capability radio resource manager 1230 may be configured as or otherwise support a means for receiving, from the UE, a capability indicator indicating a reduced capability radio resource configuration of the UE, where transmitting the control message includes transmitting a second indication to activate the reduced capability radio resource configuration of the UE for the energy harvesting mode is based on the capability indicator.

In some examples, the reduced capability radio resource manager 1230 may be configured as or otherwise support a means for transmitting, to the UE, system information indicating a reduced capability radio resource configuration for the UE, where receiving the control signaling includes transmitting a second indication to activate the reduced capability radio resource configuration of the UE for the energy harvesting mode.

In some examples, the normal capability mode indicator manager 1255 may be configured as or otherwise support a means for receiving, from the UE, a second indication that the UE is transitioning out of the energy harvesting mode to a normal capability mode.

In some examples, the normal capability mode manager 1270 may be configured as or otherwise support a means for transmitting, to the UE, a second control message indicating a second radio resource configuration for the UE during the normal capability mode.

In some examples, to support receiving the second indication that the UE is transitioning out of the energy harvesting mode to the normal capability mode, the control signaling manager 1265 may be configured as or otherwise support a means for receiving the second indication via a medium access control control element message or a radio resource control message.

In some examples, the energy harvesting mode indicator manager 1225 may be configured as or otherwise support a means for receiving, from the UE, the indication or a second indication that the UE is extending a duration of the energy harvesting mode.

In some examples, to support receiving the indication or the second indication that the UE is extending the duration of the energy harvesting mode, the control signaling manager 1265 may be configured as or otherwise support a means for receiving the indication or the second indication via a medium access control control element message or a radio resource control message.

In some examples, the idle mode manager 1260 may be configured as or otherwise support a means for transmitting, to the UE, control signaling indicating for the UE to enter an idle mode, where the control signaling is based on a duration of the energy harvesting mode.

In some examples, to support transmitting the control signaling indicating for the UE to enter the idle mode, the control signaling manager 1265 may be configured as or otherwise support a means for transmitting the control signaling via a medium access control control element message or a radio resource control message.

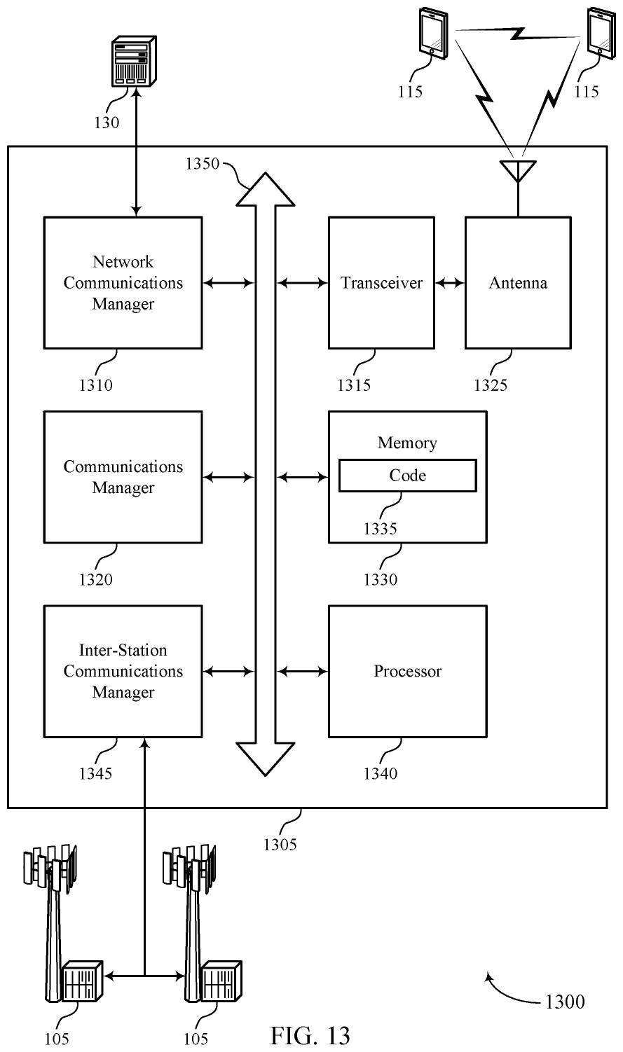

FIG. 13 shows a diagram of a system 1300 including a device 1305 that supports signaling and procedure of energy harvesting indication and energy harvesting mode in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting signaling and procedure of energy harvesting indication and energy harvesting mode). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for receiving, from a UE, an indication that the UE is transitioning to an energy harvesting mode based on a trigger, and a timing offset parameter indicating a timing offset between transmission of the indication and transitioning to the energy harvesting mode. The communications manager 1320 may be configured as or otherwise support a means for transmitting, to the UE, a control message indicating a radio resource configuration for the energy harvesting mode, prior to the UE transitioning to the energy harvesting mode. The communications manager 1320 may be configured as or otherwise support a means for communicating with the UE using the radio resource configuration during the energy harvesting mode.

By including or configuring the communications manager 1320 in accordance with examples as described herein, the device 1305 may support techniques for reduced power consumption and more efficient utilization of communication resources, for example by receiving signaling indicating that a UE 115 is transitioning into an energy harvesting mode, and transmitting, to the UE 115, in response, a radio resource configuration for the energy harvesting mode.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of signaling and procedure of energy harvesting indication and energy harvesting mode as described herein, or the processor 1340 and the memory 1330 may be otherwise configured to perform or support such operations.

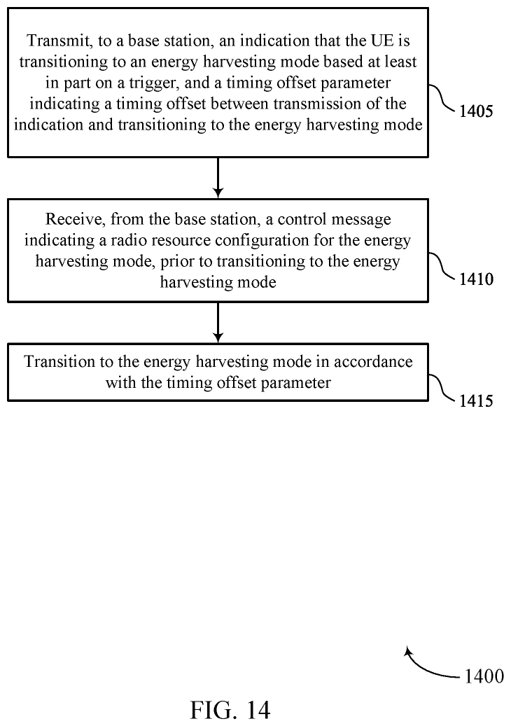

FIG. 14 shows a flowchart illustrating a method 1400 that supports signaling and procedure of energy harvesting indication and energy harvesting mode in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, an indication that the UE is transitioning to an energy harvesting mode based on a trigger, and a timing offset parameter indicating a timing offset between transmission of the indication and transitioning to the energy harvesting mode. The operations of 1405 may be performed in accordance with examples as disclosed herein. In some examples, aspects of the operations of 1405 may be performed by an energy harvesting mode indicator manager 825 as described with reference to FIG. 8.

At 1410, the method may include receiving, from the base station, a control message indicating a radio resource configuration for the energy harvesting mode, prior to transitioning to the energy harvesting mode. The operations of 1410 may be performed in accordance with examples as disclosed herein. In some examples, aspects of the operations of 1410 may be performed by a control signaling manager 830 as described with reference to FIG. 8.

At 1415, the method may include transitioning to the energy harvesting mode in accordance with the timing offset parameter. The operations of 1415 may be performed in accordance with examples as disclosed herein. In some examples, aspects of the operations of 1415 may be performed by an energy harvesting mode manager 835 as described with reference to FIG. 8.

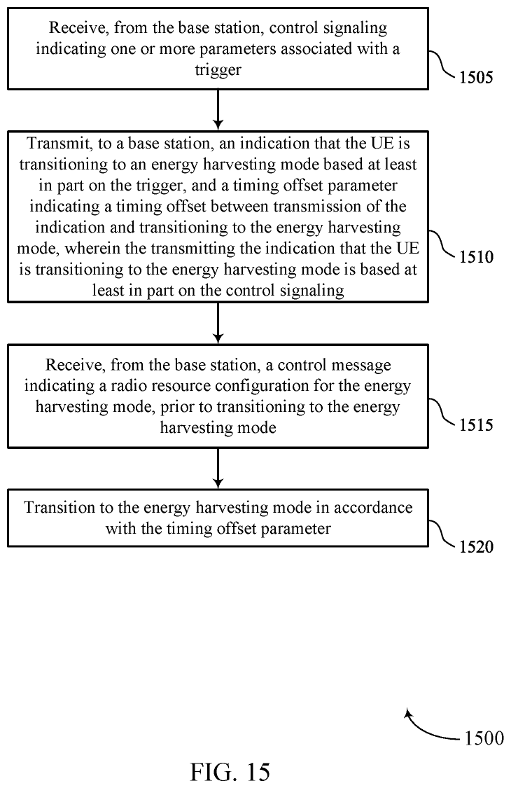

FIG. 15 shows a flowchart illustrating a method 1500 that supports signaling and procedure of energy harvesting indication and energy harvesting mode in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from the base station, control signaling indicating one or more parameters associated with a trigger. The operations of 1505 may be performed in accordance with examples as disclosed herein. In some examples, aspects of the operations of 1505 may be performed by a control signaling manager 830 as described with reference to FIG. 8.

At 1510, the method may include transmitting, to a base station, an indication that the UE is transitioning to an energy harvesting mode based on the trigger, and a timing offset parameter indicating a timing offset between transmission of the indication and transitioning to the energy harvesting mode, where the transmitting the indication that the UE is transitioning to the energy harvesting mode is based on the control signaling. The operations of 1510 may be performed in accordance with examples as disclosed herein. In some examples, aspects of the operations of 1510 may be performed by an energy harvesting mode indicator manager 825 as described with reference to FIG. 8.

At 1515, the method may include receiving, from the base station, a control message indicating a radio resource configuration for the energy harvesting mode, prior to transitioning to the energy harvesting mode. The operations of 1515 may be performed in accordance with examples as disclosed herein. In some examples, aspects of the operations of 1515 may be performed by a control signaling manager 830 as described with reference to FIG. 8.

At 1520, the method may include transitioning to the energy harvesting mode in accordance with the timing offset parameter. The operations of 1520 may be performed in accordance with examples as disclosed herein. In some examples, aspects of the operations of 1520 may be performed by an energy harvesting mode manager 835 as described with reference to FIG. 8.

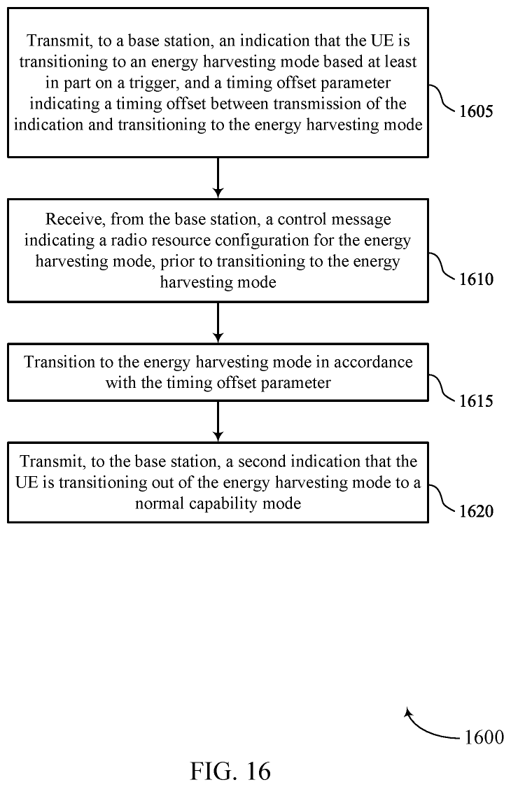

FIG. 16 shows a flowchart illustrating a method 1600 that supports signaling and procedure of energy harvesting indication and energy harvesting mode in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include transmitting, to a base station, an indication that the UE is transitioning to an energy harvesting mode based on a trigger, and a timing offset parameter indicating a timing offset between transmission of the indication and transitioning to the energy harvesting mode. The operations of 1605 may be performed in accordance with examples as disclosed herein. In some examples, aspects of the operations of 1605 may be performed by an energy harvesting mode indicator manager 825 as described with reference to FIG. 8.

At 1610, the method may include receiving, from the base station, a control message indicating a radio resource configuration for the energy harvesting mode, prior to transitioning to the energy harvesting mode. The operations of 1610 may be performed in accordance with examples as disclosed herein. In some examples, aspects of the operations of 1610 may be performed by a control signaling manager 830 as described with reference to FIG. 8.

At 1615, the method may include transitioning to the energy harvesting mode in accordance with the timing offset parameter. The operations of 1615 may be performed in accordance with examples as disclosed herein. In some examples, aspects of the operations of 1615 may be performed by an energy harvesting mode manager 835 as described with reference to FIG. 8.

At 1620, the method may include transmitting, to the base station, a second indication that the UE is transitioning out of the energy harvesting mode to a normal capability mode. The operations of 1620 may be performed in accordance with examples as disclosed herein. In some examples, aspects of the operations of 1620 may be performed by a normal capability mode indicator manager 860 as described with reference to FIG. 8.

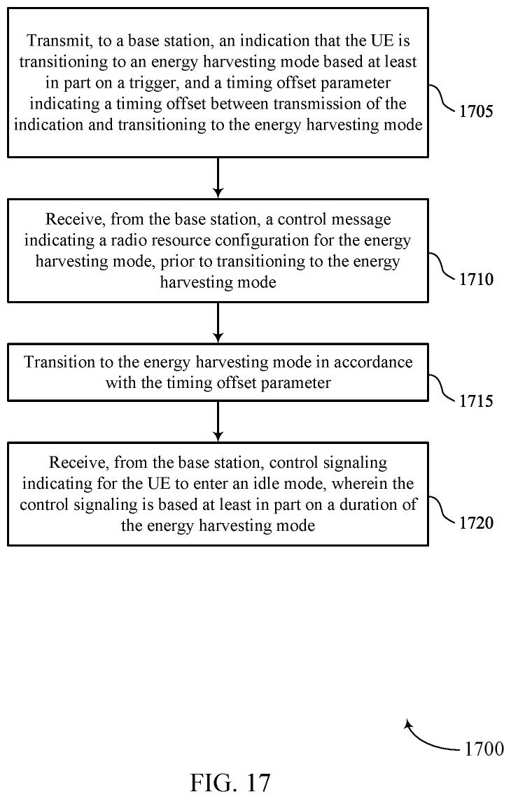

FIG. 17 shows a flowchart illustrating a method 1700 that supports signaling and procedure of energy harvesting indication and energy harvesting mode in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include transmitting, to a base station, an indication that the UE is transitioning to an energy harvesting mode based on a trigger, and a timing offset parameter indicating a timing offset between transmission of the indication and transitioning to the energy harvesting mode. The operations of 1705 may be performed in accordance with examples as disclosed herein. In some examples, aspects of the operations of 1705 may be performed by an energy harvesting mode indicator manager 825 as described with reference to FIG. 8.

At 1710, the method may include receiving, from the base station, a control message indicating a radio resource configuration for the energy harvesting mode, prior to transitioning to the energy harvesting mode. The operations of 1710 may be performed in accordance with examples as disclosed herein. In some examples, aspects of the operations of 1710 may be performed by a control signaling manager 830 as described with reference to FIG. 8.

At 1715, the method may include transitioning to the energy harvesting mode in accordance with the timing offset parameter. The operations of 1715 may be performed in accordance with examples as disclosed herein. In some examples, aspects of the operations of 1715 may be performed by an energy harvesting mode manager 835 as described with reference to FIG. 8.

At 1720, the method may include receiving, from the base station, control signaling indicating for the UE to enter an idle mode, where the control signaling is based on a duration of the energy harvesting mode. The operations of 1720 may be performed in accordance with examples as disclosed herein. In some examples, aspects of the operations of 1720 may be performed by a control signaling manager 830 as described with reference to FIG. 8.

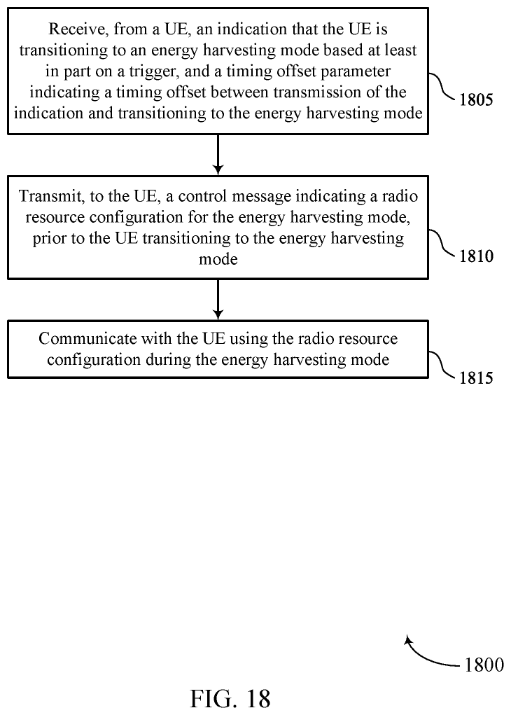

FIG. 18 shows a flowchart illustrating a method 1800 that supports signaling and procedure of energy harvesting indication and energy harvesting mode in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include receiving, from a UE, an indication that the UE is transitioning to an energy harvesting mode based on a trigger, and a timing offset parameter indicating a timing offset between transmission of the indication and transitioning to the energy harvesting mode. The operations of 1805 may be performed in accordance with examples as disclosed herein. In some examples, aspects of the operations of 1805 may be performed by an energy harvesting mode indicator manager 1225 as described with reference to FIG. 12.

At 1810, the method may include transmitting, to the UE, a control message indicating a radio resource configuration for the energy harvesting mode, prior to the UE transitioning to the energy harvesting mode. The operations of 1810 may be performed in accordance with examples as disclosed herein. In some examples, aspects of the operations of 1810 may be performed by a reduced capability radio resource manager 1230 as described with reference to FIG. 12.

At 1815, the method may include communicating with the UE using the radio resource configuration during the energy harvesting mode. The operations of 1815 may be performed in accordance with examples as disclosed herein. In some examples, aspects of the operations of 1815 may be performed by a direct link manager 1235 as described with reference to FIG. 12.

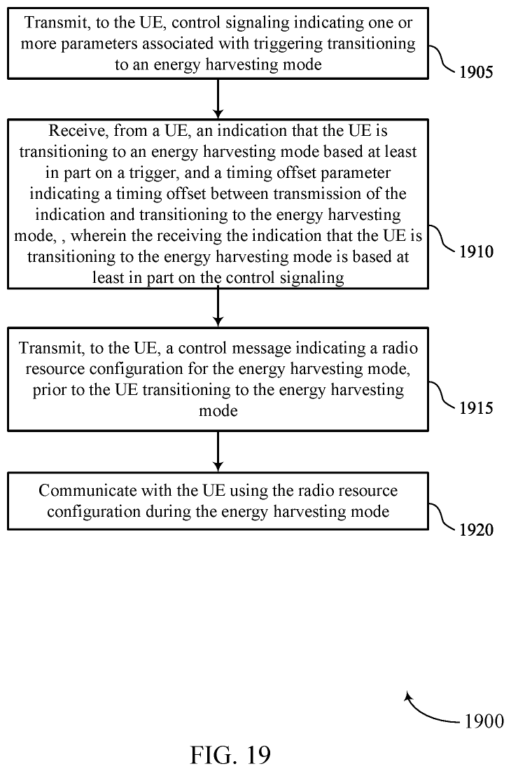

FIG. 19 shows a flowchart illustrating a method 1900 that supports signaling and procedure of energy harvesting indication and energy harvesting mode in accordance with aspects of the present disclosure. The operations of the method 1900 may be implemented by a base station or its components as described herein. For example, the operations of the method 1900 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1905, the method may include transmitting, to the UE, control signaling indicating one or more parameters associated with triggering transitioning to an energy harvesting mode. The operations of 1905 may be performed in accordance with examples as disclosed herein. In some examples, aspects of the operations of 1905 may be performed by an energy harvesting mode parameter manager 1240 as described with reference to FIG. 12.

At 1910, the method may include receiving, from a UE, an indication that the UE is transitioning to the energy harvesting mode based on a trigger, and a timing offset parameter indicating a timing offset between transmission of the indication and transitioning to the energy harvesting mode, where the receiving the indication that the UE is transitioning to the energy harvesting mode is based on the control signaling. The operations of 1910 may be performed in accordance with examples as disclosed herein. In some examples, aspects of the operations of 1910 may be performed by an energy harvesting mode indicator manager 1225 as described with reference to FIG. 12.

At 1915, the method may include transmitting, to the UE, a control message indicating a radio resource configuration for the energy harvesting mode, prior to the UE transitioning to the energy harvesting mode. The operations of 1915 may be performed in accordance with examples as disclosed herein. In some examples, aspects of the operations of 1915 may be performed by a reduced capability radio resource manager 1230 as described with reference to FIG. 12.

At 1920, the method may include communicating with the UE using the radio resource configuration during the energy harvesting mode. The operations of 1920 may be performed in accordance with examples as disclosed herein. In some examples, aspects of the operations of 1920 may be performed by a direct link manager 1235 as described with reference to FIG. 12.

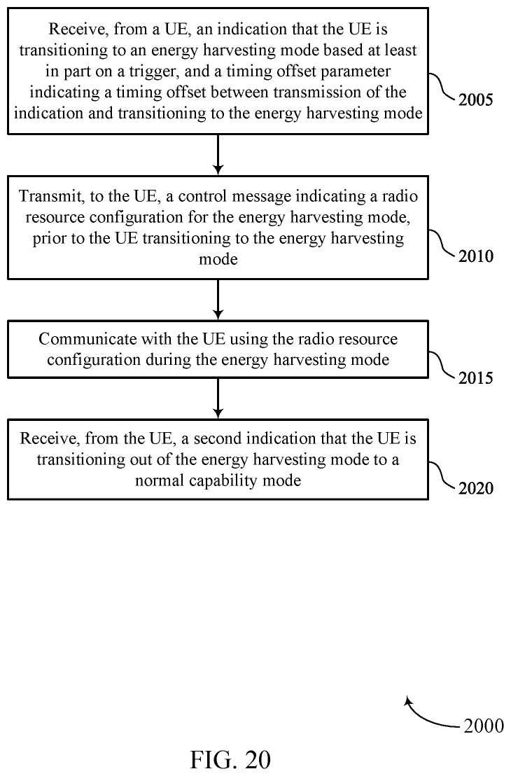

FIG. 20 shows a flowchart illustrating a method 2000 that supports signaling and procedure of energy harvesting indication and energy harvesting mode in accordance with aspects of the present disclosure. The operations of the method 2000 may be implemented by a base station or its components as described herein. For example, the operations of the method 2000 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2005, the method may include receiving, from a UE, an indication that the UE is transitioning to an energy harvesting mode based on a trigger, and a timing offset parameter indicating a timing offset between transmission of the indication and transitioning to the energy harvesting mode. The operations of 2005 may be performed in accordance with examples as disclosed herein. In some examples, aspects of the operations of 2005 may be performed by an energy harvesting mode indicator manager 1225 as described with reference to FIG. 12.

At 2010, the method may include transmitting, to the UE, a control message indicating a radio resource configuration for the energy harvesting mode, prior to the UE transitioning to the energy harvesting mode. The operations of 2010 may be performed in accordance with examples as disclosed herein. In some examples, aspects of the operations of 2010 may be performed by a reduced capability radio resource manager 1230 as described with reference to FIG. 12.

At 2015, the method may include communicating with the UE using the radio resource configuration during the energy harvesting mode. The operations of 2015 may be performed in accordance with examples as disclosed herein. In some examples, aspects of the operations of 2015 may be performed by a direct link manager 1235 as described with reference to FIG. 12.

At 2020, the method may include receiving, from the UE, a second indication that the UE is transitioning out of the energy harvesting mode to a normal capability mode. The operations of 2020 may be performed in accordance with examples as disclosed herein. In some examples, aspects of the operations of 2020 may be performed by a normal capability mode indicator manager 1255 as described with reference to FIG. 12.

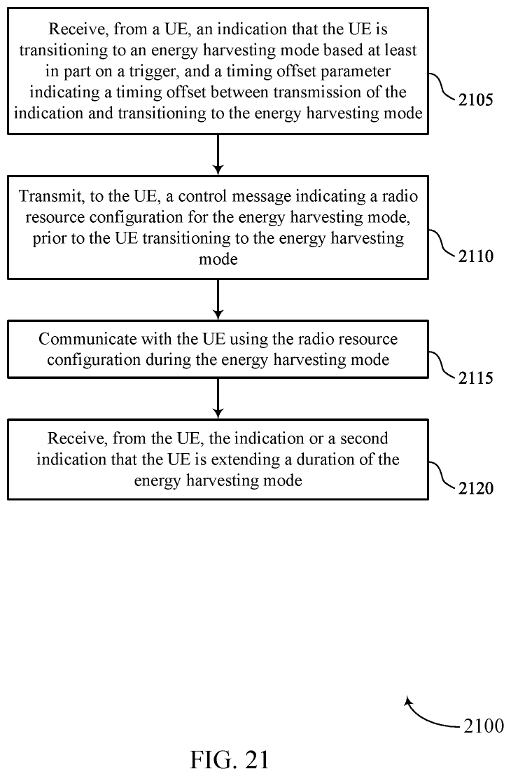

FIG. 21 shows a flowchart illustrating a method 2100 that supports signaling and procedure of energy harvesting indication and energy harvesting mode in accordance with aspects of the present disclosure. The operations of the method 2100 may be implemented by a base station or its components as described herein. For example, the operations of the method 2100 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2105, the method may include receiving, from a UE, an indication that the UE is transitioning to an energy harvesting mode based on a trigger, and a timing offset parameter indicating a timing offset between transmission of the indication and transitioning to the energy harvesting mode. The operations of 2105 may be performed in accordance with examples as disclosed herein. In some examples, aspects of the operations of 2105 may be performed by an energy harvesting mode indicator manager 1225 as described with reference to FIG. 12.

At 2110, the method may include transmitting, to the UE, a control message indicating a radio resource configuration for the energy harvesting mode, prior to the UE transitioning to the energy harvesting mode. The operations of 2110 may be performed in accordance with examples as disclosed herein. In some examples, aspects of the operations of 2110 may be performed by a reduced capability radio resource manager 1230 as described with reference to FIG. 12.

At 2115, the method may include communicating with the UE using the radio resource configuration during the energy harvesting mode. The operations of 2115 may be performed in accordance with examples as disclosed herein. In some examples, aspects of the operations of 2115 may be performed by a direct link manager 1235 as described with reference to FIG. 12.

At 2120, the method may include receiving, from the UE, the indication or a second indication that the UE is extending a duration of the energy harvesting mode. The operations of 2120 may be performed in accordance with examples as disclosed herein. In some examples, aspects of the operations of 2120 may be performed by an energy harvesting mode indicator manager 1225 as described with reference to FIG. 12.

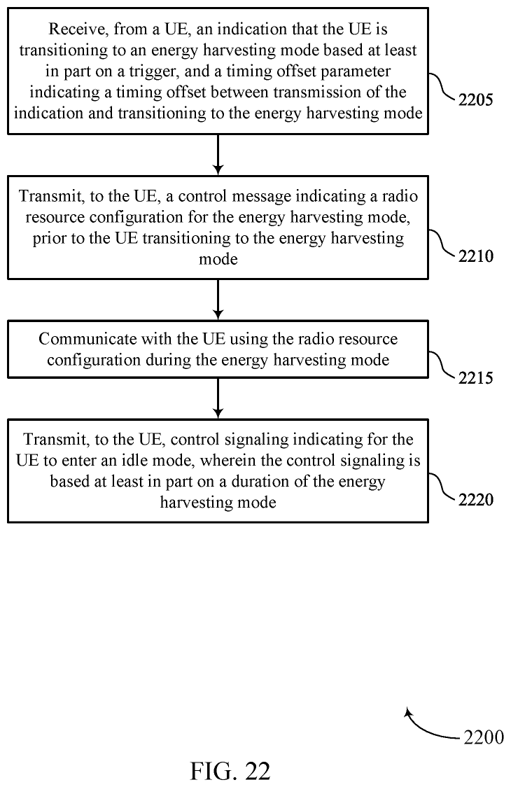

FIG. 22 shows a flowchart illustrating a method 2200 that supports signaling and procedure of energy harvesting indication and energy harvesting mode in accordance with aspects of the present disclosure. The operations of the method 2200 may be implemented by a base station or its components as described herein. For example, the operations of the method 2200 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2205, the method may include receiving, from a UE, an indication that the UE is transitioning to an energy harvesting mode based on a trigger, and a timing offset parameter indicating a timing offset between transmission of the indication and transitioning to the energy harvesting mode. The operations of 2205 may be performed in accordance with examples as disclosed herein. In some examples, aspects of the operations of 2205 may be performed by an energy harvesting mode indicator manager 1225 as described with reference to FIG. 12.

At 2210, the method may include transmitting, to the UE, a control message indicating a radio resource configuration for the energy harvesting mode, prior to the UE transitioning to the energy harvesting mode. The operations of 2210 may be performed in accordance with examples as disclosed herein. In some examples, aspects of the operations of 2210 may be performed by a reduced capability radio resource manager 1230 as described with reference to FIG. 12.

At 2215, the method may include communicating with the UE using the radio resource configuration during the energy harvesting mode. The operations of 2215 may be performed in accordance with examples as disclosed herein. In some examples, aspects of the operations of 2215 may be performed by a direct link manager 1235 as described with reference to FIG. 12.

At 2220, the method may include transmitting, to the UE, control signaling indicating for the UE to enter an idle mode, where the control signaling is based on a duration of the energy harvesting mode. The operations of 2220 may be performed in accordance with examples as disclosed herein. In some examples, aspects of the operations of 2220 may be performed by an idle mode manager 1260 as described with reference to FIG. 12.

The following provides an overview of aspects of the present disclosure:

Aspect 1: A method for wireless communications at a UE, comprising: transmitting, to a base station, an indication that the UE is transitioning to an energy harvesting mode based at least in part on a trigger, and a timing offset parameter indicating a timing offset between transmission of the indication and transitioning to the energy harvesting mode; receiving, from the base station, a control message indicating a radio resource configuration for the energy harvesting mode, prior to transitioning to the energy harvesting mode; and transitioning to the energy harvesting mode in accordance with the timing offset parameter.

Aspect 2: The method of aspect 1, further comprising: performing energy harvesting when the UE is in a radio resource control idle mode, a radio resource control inactive mode, or a radio resource control connected mode.

Aspect 3: The method of any of aspects 1 through 2, further comprising: communicating with the base station using the radio resource configuration during the energy harvesting mode.

Aspect 4: The method of any of aspects 1 through 3, further comprising: maintaining a timer indicating a duration since a previous transmission by the UE of a previous indication that the UE is transitioning to the energy harvesting mode, wherein transmitting the indication is based at least in part on the timer exceeding a threshold duration.

Aspect 5: The method of any of aspects 1 through 4, further comprising: receiving, from the base station, control signaling indicating one or more parameters associated with the trigger, wherein the transmitting the indication that the UE is transitioning to the energy harvesting mode is based at least in part on the control signaling.

Aspect 6: The method of aspect 5, wherein receiving the control signaling comprises: receiving the control signaling via dedicated radio resource control signaling or a system information block.

Aspect 7: The method of any of aspects 5 through 6, wherein the one or more parameters comprises an energy level threshold, and the trigger is based at least in part on an energy level being below the energy level threshold.

Aspect 8: The method of any of aspects 5 through 7, wherein the one or more parameters comprises an energy level threshold and a duration threshold, and the trigger is based at least in part on an energy level of the UE being below the energy level threshold for at least the duration threshold.

Aspect 9: The method of any of aspects 5 through 8, wherein, the one or more parameters comprises an energy level change threshold, and the trigger is based at least in part on a change in an energy level of the UE exceeding the energy level change threshold

Aspect 10: The method of any of aspects 1 through 9, further comprising: transmitting, to the base station, a scheduling request for an uplink resource; and receiving, from the base station, a grant for the uplink resource based at least in part on the scheduling request, and wherein transmitting the indication that the UE is transitioning to the energy harvesting mode comprises transmitting the indication via the uplink resource.

Aspect 11: The method of any of aspects 1 through 10, wherein transmitting the indication that the UE is transitioning to the energy harvesting mode comprises: transmitting the indication in a random access channel procedure.

Aspect 12: The method of any of aspects 1 through 11, wherein transmitting the indication that the UE is transitioning to the energy harvesting mode comprises: transmitting the indication via a small data transmission.

Aspect 13: The method of any of aspects 1 through 12, wherein transmitting the indication comprises: transmitting: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

Aspect 14: The method of aspect 13, further comprising: restarting a timer associated with the timer parameter based at least in part on receiving the control message from the base station.

Aspect 15: The method of any of aspects 1 through 14, wherein receiving the control message comprises: receiving a second indication of a reduced capability radio resource configuration for the energy harvesting mode.

Aspect 16: The method of any of aspects 1 through 15, further comprising: receiving, from the base station, control signaling indicating a plurality of reduced radio resource configurations, and wherein receiving the control message comprises receiving a second indication of a reduced capability radio resource configuration of the plurality of reduced radio resource configurations.

Aspect 17: The method of aspect 16, wherein receiving the control signaling comprises: receiving the control signaling via a radio resource control signal, wherein receiving the second indication comprises: receiving the second indication via a medium access control element signal or via a downlink control information signal.

Aspect 18: The method of any of aspects 1 through 17, further comprising: transmitting, to the base station, a capability indicator indicating a reduced capability radio resource configuration of the UE, wherein receiving the control message comprises receiving a second indication to activate the reduced capability radio resource configuration of the UE for the energy harvesting mode based at least in part on the capability indicator.

Aspect 19: The method of any of aspects 1 through 18, further comprising: receiving system information indicating a reduced capability radio resource configuration for the UE, wherein receiving the control message comprises receiving a second indication to activate the reduced capability radio resource configuration of the UE for the energy harvesting mode.

Aspect 20: The method of any of aspects 1 through 19, further comprising: transmitting, to the base station, a second indication that the UE is transitioning out of the energy harvesting mode to a normal capability mode.

Aspect 21: The method of aspect 20, further comprising: receiving, from the base station, a second control message indicating a second radio resource configuration for the UE during the normal capability mode.

Aspect 22: The method of any of aspects 20 through 21, further comprising: maintaining a timer indicating a duration since a previous transmission by the UE of a previous indication that the UE is transitioning out of the energy harvesting mode to the normal capability mode, wherein transmitting the indication is based at least in part on the timer exceeding a threshold duration.

Aspect 23: The method of any of aspects 20 through 22, wherein transmitting the second indication that the UE is transitioning out of the energy harvesting mode to the normal capability mode comprises: transmitting the second indication via a medium access control control element message or a radio resource control message.

Aspect 24: The method of any of aspects 1 through 23, further comprising: transmitting, to the base station, the indication or a second indication that the UE is extending a duration of the energy harvesting mode.

Aspect 25: The method of aspect 24, wherein transmitting the indication or the second indication that the UE is extending the duration of the energy harvesting mode comprises: transmitting the indication or the second indication via a medium access control control element message or a radio resource control message.

Aspect 26: The method of any of aspects 1 through 25, further comprising: receiving, from the base station, control signaling indicating for the UE to enter an idle mode, wherein the control signaling is based at least in part on a duration of the energy harvesting mode.

Aspect 27: The method of aspect 26, wherein receiving the control signaling comprises: receiving the control signaling via a medium access control control element message or a radio resource control message.

Aspect 28: A method for wireless communications at a base station, comprising: receiving, from a UE, an indication that the UE is transitioning to an energy harvesting mode based at least in part on a trigger, and a timing offset parameter indicating a timing offset between transmission of the indication and transitioning to the energy harvesting mode; transmitting, to the UE, a control message indicating a radio resource configuration for the energy harvesting mode, prior to the UE transitioning to the energy harvesting mode; and communicating with the UE using the radio resource configuration during the energy harvesting mode.

Aspect 29: The method of aspect 28, further comprising: transmitting, to the UE, control signaling indicating one or more parameters associated with triggering transitioning to the energy harvesting mode, wherein the receiving the indication that the UE is transitioning to the energy harvesting mode is based at least in part on the control signaling.

Aspect 30: The method of aspect 29, wherein transmitting the control signaling comprises: transmitting the control signaling via dedicated radio resource control signaling or a system information block.

Aspect 31: The method of any of aspects 29 through 30, wherein the one or more parameters comprises an energy level threshold, and the trigger is based at least in part on an energy level being below the energy level threshold.

Aspect 32: The method of any of aspects 29 through 31, wherein the one or more parameters comprises an energy level threshold and a duration threshold, the trigger is based at least in part on an energy level of the UE being below the energy level threshold for at least the duration threshold.

Aspect 33: The method of any of aspects 29 through 32, wherein the one or more parameters comprises an energy level change threshold, the trigger is based at least in part on a change in an energy level of the UE exceeding the energy level change threshold.

Aspect 34: The method of any of aspects 28 through 33, further comprising: receiving, from the UE, a scheduling request for an uplink resource; and transmitting, to the UE, a grant for the uplink resource based at least in part on the scheduling request, and wherein receiving the indication that the UE is transitioning to the energy harvesting mode comprises receiving the indication via the uplink resource.

Aspect 35: The method of any of aspects 28 through 34, wherein receiving the indication that the UE is transitioning to the energy harvesting mode comprises:

receiving the indication in a random access channel procedure.

Aspect 36: The method of any of aspects 28 through 35, wherein receiving the indication that the UE is transitioning to the energy harvesting mode comprises: receiving the indication via a small data transmission.

Aspect 37: The method of any of aspects 28 through 36, wherein receiving the indication comprises: receiving: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

Aspect 38: The method of any of aspects 28 through 37, wherein transmitting the control message comprises: transmitting a second indication of a reduced capability radio resource configuration for the UE during the energy harvesting mode.

Aspect 39: The method of any of aspects 28 through 38, further comprising: transmitting, to the UE, control signaling indicating a plurality of reduced radio resource configurations, and wherein transmitting the control message comprises transmitting a second indication of a reduced capability radio resource configuration of the plurality of reduced radio resource configurations.

Aspect 40: The method of aspect 39, wherein transmitting the control signaling comprises: transmitting the control signaling via a radio resource control signal, and wherein transmitting the second indication comprises transmitting the second indication via a medium access control control element signal or via a downlink control information signal.

Aspect 41: The method of any of aspects 28 through 40, further comprising: receiving, from the UE, a capability indicator indicating a reduced capability radio resource configuration of the UE, wherein transmitting the control message comprises transmitting a second indication to activate the reduced capability radio resource configuration of the UE for the energy harvesting mode is based at least in part on the capability indicator.

Aspect 42: The method of any of aspects 28 through 41, further comprising: transmitting, to the UE, system information indicating a reduced capability radio resource configuration for the UE, wherein transmitting the control message comprises transmitting a second indication to activate the reduced capability radio resource configuration of the UE for the energy harvesting mode.

Aspect 43: The method of any of aspects 28 through 42, further comprising: receiving, from the UE, a second indication that the UE is transitioning out of the energy harvesting mode to a normal capability mode.

Aspect 44: The method of aspect 43, further comprising: transmitting, to the UE, a second control message indicating a second radio resource configuration for the UE during the normal capability mode.

Aspect 45: The method of any of aspects 43 through 44, wherein receiving the second indication that the UE is transitioning out of the energy harvesting mode to the normal capability mode comprises: receiving the second indication via a medium access control control element message or a radio resource control message.

Aspect 46: The method of any of aspects 28 through 45, further comprising: receiving, from the UE, the indication or a second indication that the UE is extending a duration of the energy harvesting mode.

Aspect 47: The method of aspect 46, wherein receiving the indication or the second indication that the UE is extending the duration of the energy harvesting mode comprises: receiving the indication or the second indication via a medium access control control element message or a radio resource control message.

Aspect 48: The method of any of aspects 28 through 47, further comprising: transmitting, to the UE, control signaling indicating for the UE to enter an idle mode, wherein the control signaling is based at least in part on a duration of the energy harvesting mode.

Aspect 49: The method of aspect 48, wherein transmitting the control signaling indicating for the UE to enter the idle mode comprises: transmitting the control signaling via a medium access control control element message or a radio resource control message.

Aspect 50: An apparatus for wireless communications at a UE, comprising a processor; memory coupled with the processor; and instructions stored in the memory and executable by the processor to cause the apparatus to perform a method of any of aspects 1 through 27.

Aspect 51: An apparatus for wireless communications at a UE, comprising at least one means for performing a method of any of aspects 1 through 27.

Aspect 52: A non-transitory computer-readable medium storing code for wireless communications at a UE, the code comprising instructions executable by a processor to perform a method of any of aspects 1 through 27.

Aspect 53: An apparatus for wireless communications at a base station, comprising a processor; memory coupled with the processor; and instructions stored in the memory and executable by the processor to cause the apparatus to perform a method of any of aspects 28 through 49.

Aspect 54: An apparatus for wireless communications at a base station, comprising at least one means for performing a method of any of aspects 28 through 49.

Aspect 55: A non-transitory computer-readable medium storing code for wireless communications at a base station, the code comprising instructions executable by a processor to perform a method of any of aspects 28 through 49.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1.-49. (canceled)

50. An apparatus for wireless communications at a user equipment (UE), comprising:
one or more processors,
one or more memories coupled with the one or more processors; and
instructions stored in the one or more memories and executable by the one or more processors to cause the apparatus to:
transmit, to a base station, an indication that the UE is transitioning to an energy harvesting mode based at least in part on a trigger, and a timing offset parameter indicating a timing offset between transmission of the indication and transitioning to the energy harvesting mode;
receive, from the base station, a control message indicating a radio resource configuration for the energy harvesting mode, prior to transitioning to the energy harvesting mode; and
transition to the energy harvesting mode in accordance with the timing offset parameter.

51. The apparatus of claim 50, wherein the instructions are further executable by the one or more processors to cause the apparatus to:
perform energy harvesting when the UE is in a radio resource control idle mode, a radio resource control inactive mode, or a radio resource control connected mode.

52. The apparatus of claim 50, wherein the instructions are further executable by the one or more processors to cause the apparatus to:
communicate with the base station using the radio resource configuration during the energy harvesting mode.

53. The apparatus of claim 50, wherein the instructions are further executable by the one or more processors to cause the apparatus to:
maintain a timer indicating a duration since a previous transmission by the UE of a previous indication that the UE is transitioning to the energy harvesting mode, wherein transmitting the indication is based at least in part on the timer exceeding a threshold duration.

54. The apparatus of claim 50, wherein the instructions are further executable by the one or more processors to cause the apparatus to:
receive, from the base station, control signaling indicating one or more parameters associated with the trigger, wherein the indication that the UE is transitioning to the energy harvesting mode is transmitted based at least in part on the control signaling.

55. The apparatus of claim 54, wherein the instructions to receive the control signaling are executable by the one or more processors to cause the apparatus to:
receive the control signaling via dedicated radio resource control signaling or a system information block.

56. The apparatus of claim 54, wherein:
the one or more parameters comprises an energy level threshold, and
the trigger is based at least in part on an energy level being below the energy level threshold.

57. The apparatus of claim 54, wherein:
the one or more parameters comprises an energy level threshold and a duration threshold, and
the trigger is based at least in part on an energy level of the UE being below the energy level threshold for at least the duration threshold.

58. The apparatus of claim 54, wherein:
the one or more parameters comprises an energy level change threshold, and
the trigger is based at least in part on a change in an energy level of the UE exceeding the energy level change threshold.

59. The apparatus of claim 50, wherein the instructions are further executable by the one or more processors to cause the apparatus to:
transmit, to the base station, a scheduling request for an uplink resource; and
receive, from the base station, a grant for the uplink resource based at least in part on the scheduling request, and wherein transmitting the indication that the UE is transitioning to the energy harvesting mode comprises transmitting the indication via the uplink resource.

60. The apparatus of claim 50, wherein the instructions to transmit the indication that the UE is transitioning to the energy harvesting mode are executable by the one or more processors to cause the apparatus to:
transmit the indication in a random access channel procedure.

61. The apparatus of claim 50, wherein the instructions to transmit the indication that the UE is transitioning to the energy harvesting mode are executable by the one or more processors to cause the apparatus to:
transmit the indication via a small data transmission.

62. The apparatus of claim 50, wherein the instructions to transmit the indication are executable by the one or more processors processer to cause the apparatus to:
transmit: a timer parameter indicating a duration associated with the energy harvesting mode, a radio resource state parameter indicating a radio resource state associated with the UE exiting the energy harvesting mode, a preferred radio resource parameter indicating a target radio resource for the UE during the energy harvesting mode, or a combination thereof.

63. The apparatus of claim 62, wherein the instructions are further executable by the one or more processors to cause the apparatus to:
restart a timer associated with the timer parameter based at least in part on receiving the control message from the base station.

64. The apparatus of claim 50, wherein the instructions to receive the control message are executable by the one or more processors to cause the apparatus to:
receive a second indication of a reduced capability radio resource configuration for the energy harvesting mode.

65. The apparatus of claim 50, wherein the instructions are further executable by the one or more processors to cause the apparatus to:
receive, from the base station, control signaling indicating a plurality of reduced radio resource configurations, and wherein receiving the control message comprises receiving a second indication of a reduced capability radio resource configuration of the plurality of reduced radio resource configurations.

66. The apparatus of claim 65, wherein the instructions to receive the control signaling are executable by the one or more processors to cause the apparatus to:
receive the control signaling via a radio resource control signal, wherein receiving the second indication comprises:
receive the second indication via a medium access control control element signal or via a downlink control information signal.

67. The apparatus of claim 50, wherein the instructions are further executable by the one or more processors to cause the apparatus to:
transmit, to the base station, a capability indicator indicating a reduced capability radio resource configuration of the UE, wherein receiving the control message comprises receiving a second indication to activate the reduced capability radio resource configuration of the UE for the energy harvesting mode based at least in part on the capability indicator.

68. The apparatus of claim 50, wherein the instructions are further executable by the one or more processors to cause the apparatus to:
receive system information indicating a reduced capability radio resource configuration for the UE, wherein receiving the control message comprises receiving a second indication to activate the reduced capability radio resource configuration of the UE for the energy harvesting mode.

69. The apparatus of claim 50, wherein the instructions are further executable by the one or more processors to cause the apparatus to:
transmit, to the base station, a second indication that the UE is transitioning out of the energy harvesting mode to a normal capability mode.

70. The apparatus of claim 69, wherein the instructions are further executable by the one or more processors to cause the apparatus to:
receive, from the base station, a second control message indicating a second radio resource configuration for the UE during the normal capability mode.

71. The apparatus of claim 69, wherein the instructions are further executable by the one or more processors to cause the apparatus to:
maintain a timer indicating a duration since a previous transmission by the UE of a previous indication that the UE is transitioning out of the energy harvesting mode to the normal capability mode, wherein transmitting the indication is based at least in part on the timer exceeding a threshold duration.

72. The apparatus of claim 69, wherein the instructions to transmit the second indication that the UE is transitioning out of the energy harvesting mode to the normal capability mode are executable by the one or more processors to cause the apparatus to:
transmit the second indication via a medium access control control element message or a radio resource control message.

73. The apparatus of claim 50, wherein the instructions are further executable by the one or more processors to cause the apparatus to:
transmit, to the base station, the indication or a second indication that the UE is extending a duration of the energy harvesting mode.

74. The apparatus of claim 73, wherein the instructions to transmit the indication or the second indication that the UE is extending the duration of the energy harvesting mode are executable by the one or more processors to cause the apparatus to:
transmit the indication or the second indication via a medium access control control element message or a radio resource control message.

75. The apparatus of claim 50, wherein the instructions are further executable by the one or more processors to cause the apparatus to:
receive, from the base station, control signaling indicating for the UE to enter an idle mode, wherein the control signaling is based at least in part on a duration of the energy harvesting mode.

76. The apparatus of claim 75, wherein the instructions to receive the control signaling are executable by the one or more processors to cause the apparatus to:
receive the control signaling via a medium access control control element message or a radio resource control message.

77. An apparatus for wireless communications at a base station, comprising:
one or more processors;
one or more memories coupled with the one or more processors; and
instructions stored in the one or more memories memory and executable by the one or more processors to cause the apparatus to:
receive, from a user equipment (UE), an indication that the UE is transitioning to an energy harvesting mode based at least in part on a trigger, and a timing offset parameter indicating a timing offset between transmission of the indication and transitioning to the energy harvesting mode;
transmit, to the UE, a control message indicating a radio resource configuration for the energy harvesting mode, prior to the UE transitioning to the energy harvesting mode; and
communicate with the UE using the radio resource configuration during the energy harvesting mode.

78.-196. (canceled)

197. A method for wireless communications at a user equipment (UE), comprising:
transmitting, to a base station, an indication that the UE is transitioning to an energy harvesting mode based at least in part on a trigger, and a timing offset parameter indicating a timing offset between transmission of the indication and transitioning to the energy harvesting mode;
receiving, from the base station, a control message indicating a radio resource configuration for the energy harvesting mode, prior to transitioning to the energy harvesting mode; and
transitioning to the energy harvesting mode in accordance with the timing offset parameter.

198. A method for wireless communications at a base station, comprising:
receiving, from a user equipment (UE), an indication that the UE is transitioning to an energy harvesting mode based at least in part on a trigger, and a timing offset parameter indicating a timing offset between transmission of the indication and transitioning to the energy harvesting mode;
transmitting, to the UE, a control message indicating a radio resource configuration for the energy harvesting mode, prior to the UE transitioning to the energy harvesting mode; and
communicating with the UE using the radio resource configuration during the energy harvesting mode.
